(19) United States
(12) Patent Application Publication
(10) Pub. No.: US 2019/0043015 A1
(43) Pub. Date: Feb. 7, 2019

(54) SHIPPING ASSISTANCE DEVICE, SHIPPING ASSISTANCE METHOD, AND SHIPPING ASSISTANCE SYSTEM

(71) Applicant: MITSUBISHI ELECTRIC CORPORATION, Chiyoda-ku, Tokyo (JP)

(72) Inventors: Tomoharu Nakano, Tokyo (JP); Minako Nagata, Tokyo (JP); Taisuke Fukazawa, Tokyo (JP)

(73) Assignee: MITSUBISHI ELECTRIC CORPORATION, Chiyoda-ku, Tokyo (JP)

(21) Appl. No.: 16/075,774

(22) PCT Filed: Jan. 5, 2017
(86) PCT No.: PCT/JP2017/000152

§ 371 Date: Aug. 6, 2018

(30) Foreign Application Priority Data
Feb. 25, 2016 (JP) 2016-033722

(51) Int. Cl. G06Q 10/08; G06Q 10/06

(52) U.S. Cl. CPC G06Q 10/08355; G06Q 10/087; G06Q 10/06316

(57) ABSTRACT

A shipping assistance device includes an order information acquirer, a shippable product storage-site information acquirer, a shipping schedule information acquirer, a shipping product storage-site selector, and an outputter. The order information acquirer acquires order information containing an ordered product, a delivery due-date and a delivery destination. The shippable product storage-site information acquirer acquires information indicating a product storage-site that is able to ship the ordered product. The shipping schedule information acquirer acquires shipping schedule information for each product storage-site indicated with the information which the shippable product storage-site information acquirer has acquired, the shipping schedule information containing a shipping schedule date and a delivery destination for the product that is scheduled to be shipped from a particular product storage-site. The shipping product storage-site selector selects a product storage-site based on the order information and the shipping schedule information. The outputter outputs information indicating the selected product storage-site.

### TECHNICAL FIELD

The present disclosure relates to a shipping assistance device, a shipping assistance method, a program, and a shipping assistance system.

### BACKGROUND ART

Techniques that enable implementation of efficient delivery are being developed. Patent literature 1, for example, discloses a technique that improves inventory and delivery cost-effectiveness by retrieving inventory close to a delivery destination among inventories located in various locations belonging to sellers who are distributors, and performing both product shipping and processing of payment on behalf of a party who originally received an order.

### CITATION LIST

### Patent Literature

Patent Literature 1: Unexamined Japanese Patent Application Kokai Publication No. 2006-176231

### SUMMARY OF INVENTION

### Technical Problem

With the technique in patent literature 1, even where there is a product storage-site with an existing shipping schedule containing a delivery due-date and a delivery destination that are similar to that of a new order received from an order originator, an existing shipment to be sent from the product storage-site and a shipment corresponding to the new order cannot be consolidated together and shipped from the same product storage-site. Consequently the shipments have to be sent from different product storage-sites, thereby increasing strain on the order originator when receiving packages, which is problematic.

In consideration of circumstances such as those described above, an objective of the present disclosure is to improve task-efficiency for the receipt of packages by the order originator by consolidating multiple shipments corresponding to multiple orders received from the order originator.

### Solution to Problem

### Advantageous Effects of Invention

In order to achieve this objective, a shipping assistance device of the present disclosure includes an order information acquirer, a shippable product storage-site information acquirer, a shipping schedule information acquirer, a shipping product storage-site selector, and an outputter. The order information acquirer acquires order information including at least a number of types of products ordered, an order quantity, a delivery due-date, and a delivery destination. The shippable product storage-site information acquirer acquires information indicating product storage-sites that are able to ship an ordered product included in the order information acquired by the order information acquirer. The shipping schedule information acquirer acquires shipping schedule information for each product storage-site indicated in the information acquired by the shippable product storage-site information acquirer, the shipping schedule information including at least a shipping schedule date and a delivery location for a product that is scheduled to be shipped from a particular product storage-site of the product storage-sites. The shipping product storage-site selector selects, based on the delivery due-date and the delivery destination included in the order information and the shipping schedule date and the delivery location included in the shipping schedule information, a product storage-site, as a shipping product storage-site, having shipping schedule information in which the delivery destination is the delivery location and the shipping schedule date is early enough to be in time for the delivery due-date. The outputter outputs information indicating the product storage-site selected by the shipping product storage-site selector.

According to the present disclosure, since various shipments corresponding to multiple orders from the order originator can be consolidated together, the task-efficiency for the receipt of packages by the order originator can be improved.

### BRIEF DESCRIPTION OF DRAWINGS

FIG. 1 is a hardware configuration diagram of a shipping assistance device according to Embodiment 1 of the present disclosure;

FIG. 2 is a functional block diagram of the shipping assistance device according to Embodiment 1;

FIG. 3 is a flowchart of shipping product storage-site selection processing of the shipping assistance device according to Embodiment 1;

FIG. 4 is a functional block diagram of a shipping assistance system according to Embodiment 2 of the present disclosure;

FIG. 5 is a functional block diagram of a shipping assistance device according to Embodiment 3 of the present disclosure;

FIG. 6A is a flowchart of a first iteration of shipping product storage-site selection processing of the shipping assistance device according to Embodiment 3;

FIG. 6B is a flowchart of a second iteration of the shipping product storage-site selection processing of the shipping assistance device according to Embodiment 3;

FIG. 7A is a flowchart of a first iteration of per-product shipping product storage-site selection processing in a shipping assistance device according to Embodiment 4 of the present disclosure;

FIG. 7B is a flowchart of a second iteration of the per-product shipping product storage-site selection processing in the shipping assistance device according to

Embodiment 4 of the present disclosure;

FIG. 8 is a diagram illustrating an example of order originator information;

FIG. 9 is a diagram illustrating an example of product storage-site information;

FIG. 10 is a diagram illustrating an example of inventory information;

FIG. 11 is a diagram illustrating an example of shipping schedule information;

FIG. 12 is a diagram illustrating an example of priority product storage-site information;

FIG. 13 is a diagram illustrating an example of per-product shipment location information;

FIG. 14 is a diagram illustrating an example of product information; and FIG. 15 is a diagram illustrating an example of order information.

### DESCRIPTION OF EMBODIMENTS

Hereinafter, a shipping assistance device, a shipping assistance method, a program, and a shipping assistance system according to embodiments of the present disclosure are described with reference to the drawings. Throughout the drawings, components that are the same or equivalent are assigned the same reference signs.

### Embodiment 1

The shipping assistance device according to embodiments of the present disclosure is a device that determines, when a product order is received from an order originator, a product storage-site with inventory that can deliver the product just ordered, together with any products in existing orders received thus far from the order originator. The product storage-site is a facility (location, building, and the like) for storing products.

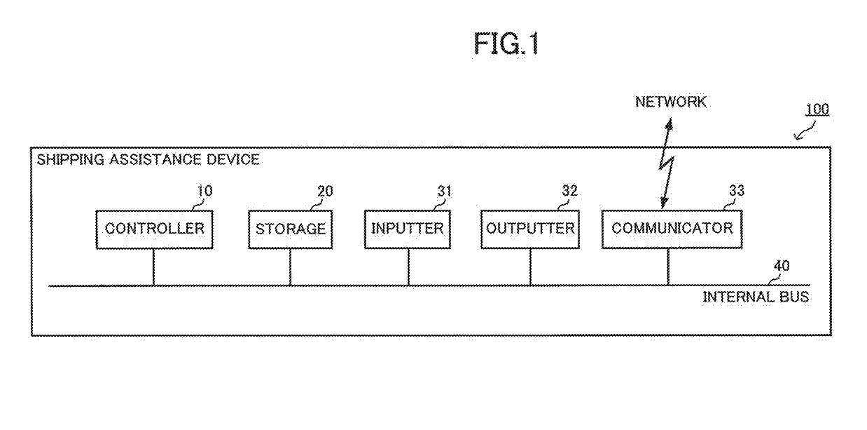

As illustrated in FIG. 1, as a hardware configuration, a shipping assistance device 100 according to Embodiment 1 of the present disclosure includes a controller 10, a storage 20, an inputter 31, an outputter 32, and a communicator 33. Each of these components is mutually connected with one another via an internal bus 40.

The controller 10 includes a central processing unit (CPU), an application specific integrated circuit (ASIC), and the like. The controller 10 accomplishes the functions of the individual components (order information acquirer 11, shippable product storage-site information acquirer 12, shipping schedule information acquirer 13, shipping product storage-site selector 14, and delivery period acquirer 15 that are described further below) of the shipping assistance device 100 by executing the programs stored in the storage 20.

The storage 20 includes components such as a read-only memory (ROM) and a random-access memory (RAM). The ROM stores programs for execution by the CPU of the controller 10 and data required beforehand for execution of the programs. The RAM stores data that is prepared, modified, and the like during program execution.

The inputter 31 includes, for example, a keyboard and a mouse for operating the shipping assistance device 100. In a case in which input is performed using voice recognition, the inputter 31 is also provided with a microphone. A user of the shipping assistance device 100 uses the inputter 31 to input orders received from order originators, and inputs instructions to the shipping assistance device 100. The outputter 32 includes, for example, a speaker and a display that is a liquid crystal display or organic electroluminescent (EL) display. The outputter 32 outputs a result requested by the shipping assistance device 100 to the user of the shipping assistance device 100. Here, the user of the shipping assistance device 100 is a shipping manager that manages the shipping of products ordered by an order originator, for example.

The communicator 33 includes a device for communicating with an external device via a network. The communicator 33 enables the shipping assistance device 100 to receive orders from order originators via the network. The communicator 33 also enables the shipping assistance device 100 to acquire inventory information, shipping schedule information, and the like of product storage-sites located in various locations via the network.

The internal bus 40 connects the controller 10, the storage 20, the inputter 31, the outputter 32, and the communicator 33 of the shipping assistance device 100 with one another and enables data to be exchanged between these components.

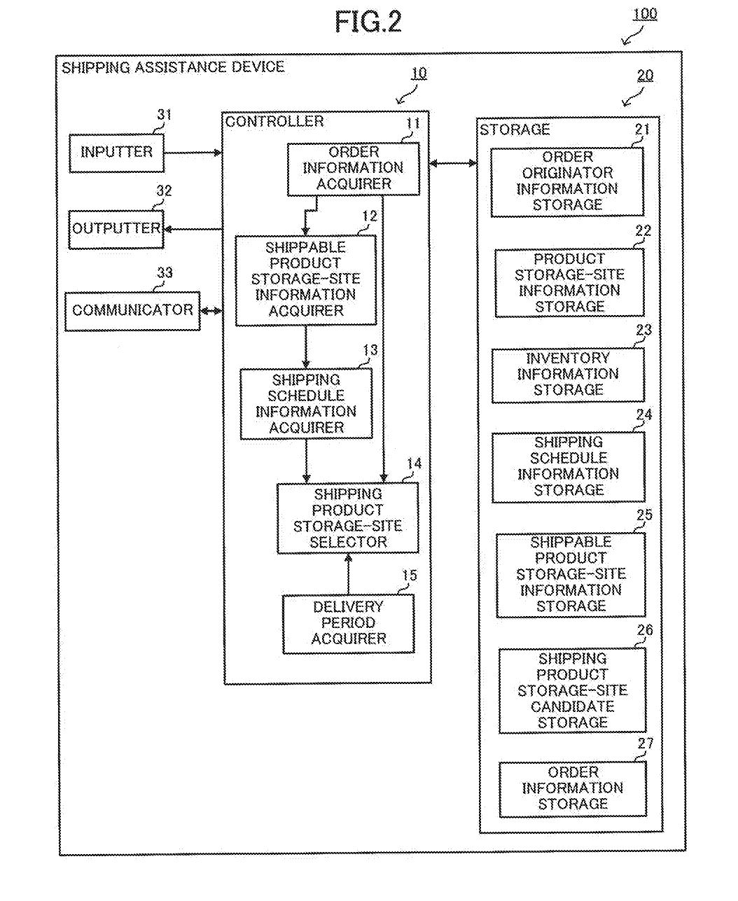

Next, functions of the components of the shipping assistance device 100 are described with reference to FIG. 2. As the controller 10, the storage 20, the inputter 31, the outputter 32, and the communicator 33 in FIG. 2 are described in the description of FIG. 1, the other components not yet described are described next. As illustrated in FIG. 2, the controller 10 of the shipping assistance device 100 accomplishes the functions of an order information acquirer 11, a shippable product storage-site information acquirer 12, a shipping schedule information acquirer 13, a shipping product storage-site selector 14, and a delivery period acquirer 15. Also, the storage 20 includes an order originator information storage 21, a product storage-site information storage 22, an inventory information storage 23, a shipping schedule information storage 24, a shippable product storage-site information storage 25, a shipping product storage-site candidate storage 26, and an order information storage 27.

The order information acquirer 11 acquires order information from the order originator. This order information, as illustrated in FIG. 15, contains various types of information including an order originator name, an order originator code, a delivery destination, a delivery due-date, a number of types of products, a product name, a product code and an order quantity. Of these types of information, three types, namely the product name, the product code, and the order quantity contain information equal in number to the types of products. FIG. 15 is a case in which the number of types of products is “2”.

The shippable product storage-site information acquirer 12 acquires information indicating a shippable product storage-site. The shippable product storage-site is a product storage-site that is able to ship the products ordered by the order originator. The shippable product storage-site is a product storage-site whose shippable inventory for the ordered product is equal to or greater than the order quantity of the products.

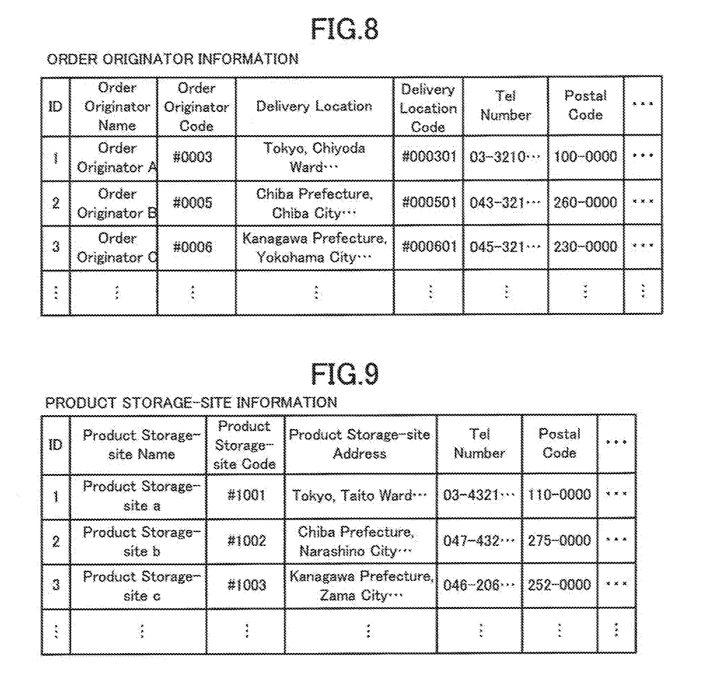

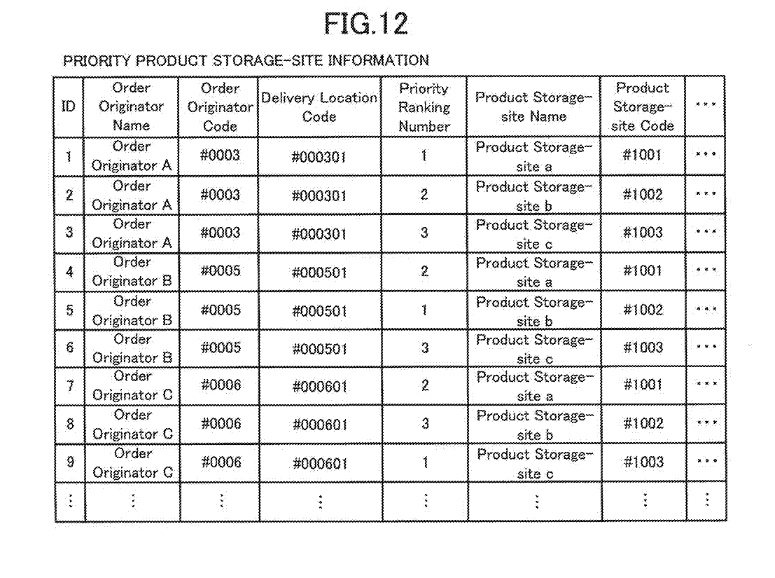

The shipping schedule information acquirer 13 acquires, from each storage-site, shipping schedule information that is information regarding existing shipping schedules for each delivery location. This shipping schedule information, as illustrated in FIG. 11, contains various types of information including a product storage-site name, a product storage-site code, an order originator name, an order originator code, a delivery location, a delivery location code, and a shipping schedule date. The item “ID” provided on the left-side of FIGS. 8 to 14 is a number for uniquely identifying the various types of information (shipping schedule information in FIG. 11).

The shipping product storage-site selector 14 selects a product storage-site that can deliver the product in presently-placed order together with products of other existing orders that are already scheduled to be shipped. In other words, the shipping product storage-site selector 14 selects, as a shipping product storage-site, a product storage-site that has, in the existing shipping schedule information for shipping to the delivery location of the order originator of presently-placed order, shipping schedule information containing a shipping schedule date early enough to be in time for a delivery due-date of the presently-placed order.

The delivery period acquirer 15 refers to the delivery period table using the address of a product storage-site and the address of a delivery destination to acquire a number of days (number of delivery days) necessary for delivery from the product storage-site to the delivery destination. Here, the delivery period table, although not illustrated, is an arrangement by prefecture of addresses of deliverers and the addresses of delivery destinations in columns and rows, respectively, and where the columns and rows meet the number of days it will take for delivery from the deliverer to the delivery destination is recorded as data in tabular form.

A specific example is described next. The presently-placed order is assumed to be an order made by order originator A as illustrated in FIG. 15 and the existing shipping schedule information is assumed to be as illustrated in FIG. 11. Also, to facilitate understanding in this example, the delivery period is assumed to be one day to anywhere within Japan. From FIG. 15, it is understood that the delivery destination for the presently-placed order is #000301 and that the delivery due-date is December 24, so the delivery location code #000301 is used to find a shipping schedule date prior to December 23 in FIG. 11. It is evident that the information in the fourth row of FIG. 11 meets this condition, and in such a case a product storage-site c is selected as the shipping product storage-site.

The order originator information storage 21 stores order originator information that is information regarding the order originator. The order originator information, as illustrated in FIG. 8, contains various types of information including an order originator name, an order originator code, a delivery location (address of the delivery destination of the order originator), a delivery location code, an order originator telephone number, and a postal code of the order originator. Each time a new order originator is acquired, the shipping assistance device 100 additionally stores order originator information regarding the new order originator into the order originator information storage 21. Conversely, if a case arises where an order originator of a prior order no longer places orders, the order information regarding the order originator who no longer places orders gets deleted from the order originator information storage 21.

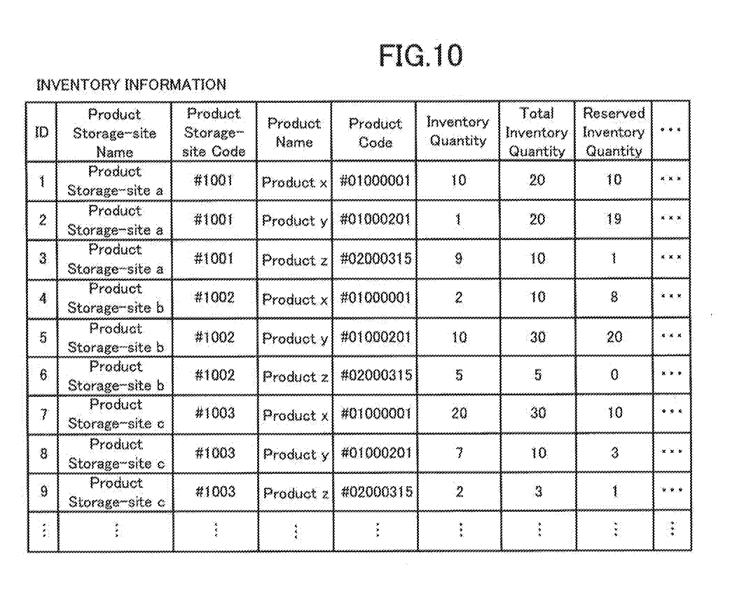

The product storage-site information storage 22 stores product storage-site information that is information regarding a product storage-site for storing products to be delivered to order originators. The product storage-site information, as illustrated in FIG. 9, contains various types of information including a product storage-site name, a product storage-site code, a product storage-site address, a product storage-site telephone number, and a product storage-site postal code. When there is a new product storage-site, the shipping assistance device 100 additionally stores product storage-site information regarding the new product storage-site into the product storage-site information storage 22. Conversely, if a case arises where a product storage-site is no longer used, the product storage-site information regarding the product storage-site that is no longer used gets deleted from the product storage-site information storage 22.

Although not illustrated, there may be a business-site information storage in addition to the product storage-site information storage 22. The business-site information, similar to the product storage-site information in FIG. 9, likewise contains various types of information including a business-site name, a business-site code, a business-site address, a business-site telephone number, and a business-site postal code. This business-site information storage is crucial for allowing an order originator to specify a business-site as a delivery destination when placing an order.

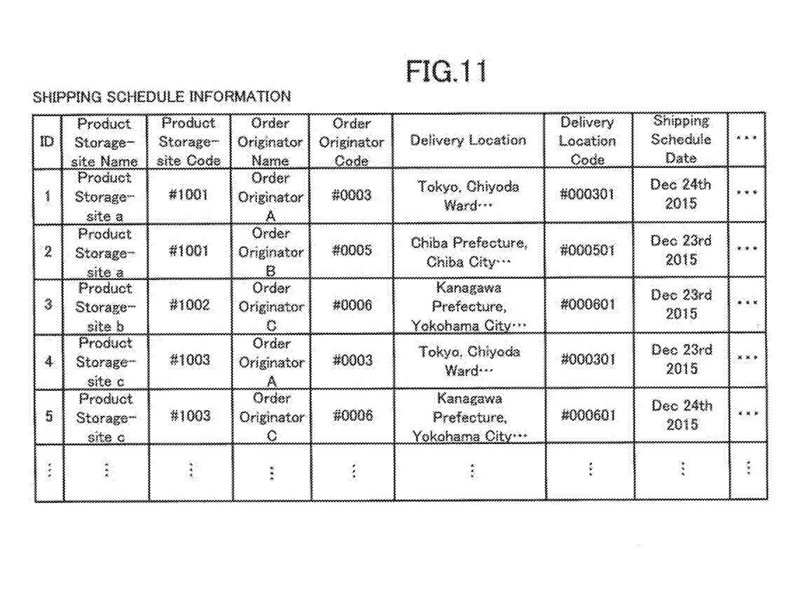

The inventory information storage 23 stores inventory information that is information regarding shippable products in the respective inventories for all product storage-sites stored in the product storage-site information storage 22. The inventory information, as illustrated in FIG. 10, contains various types of information including a product storage-site name, a product storage-site code, a product name, a product code, and an inventory quantity. The inventory quantity described here is not the actual inventory quantity (total inventory quantity of products in the product storage-site), but rather is the shippable inventory quantity. In other words, the inventory quantity is the quantity remaining after subtracting the quantity of products reserved for orders already made by an order originator from the total inventory quantity of a product existing at a product storage-site. Each time an order is received from the order originator, the controller 10 queries, via the communicator 33, each product storage-site to obtain the inventory quantity of the product included in the ordered received, and stores the inventory information obtained from the query results into the inventory information storage 23. Instead of storing inventory information in the inventory information storage 23 only when an order is received, storing may be performed each time a product arrives, a product is shipped, or a product order is received at one of the product storage-sites.

In a case where an order is received at the same time new inventory arrives or inventory is shipped and there are two or more shipping assistance devices 100 in operation at the same time, there is a possibility that the inventory quantity will be changed during shipping product storage-site selection processing described further below. This necessitates the use of exclusive control to prevent an order from being accepted at the same time any new inventory arrives or any inventory is shipped and to ensure that the shipping product storage-site selection processing is performed on only one shipping assistance device 100 at a time. The exclusive control is accomplished by using semaphore or mutex, for example.

The shipping schedule information storage 24 stores shipping schedule information that is information regarding schedules for shipping from each product storage-site to each delivery location. The shipping schedule information, as illustrated in FIG. 11, contains various types of information including a product storage-site name, a product storage-site code, an order originator name, an order originator code, a delivery location, a delivery location code, and a shipping schedule date. Each time an order is received from the order originator, the shipping schedule information acquirer 13 queries, via the communicator 33, each product storage-site to obtain the shipping schedule information, and stores the shipping schedule information obtained from the query results into the shipping schedule information storage 24. Instead of storing shipping schedule information into the shipping schedule information storage 24 only when an order is received, shipping schedule information corresponding to a new shipment instruction may be additionally stored into the shipping schedule information storage 24 each time a shipping instruction is given with respect to each of the product storage-sites. In such a case, each time the shipping is completed, the shipping schedule information corresponding to the completed shipment gets deleted from the shipping schedule information storage 24.

In a case where an order is received at the same time a new shipping instruction is given or a shipment is completed and there are two or more shipping assistance devices 100 in operation at the same time, there is a possibility that the shipping schedule information will be changed during the shipping product storage-site selection processing described further below. Therefore, this necessitates the use of the exclusive control, as is described with the inventor information, to prevent an order from being accepted at the same time any new shipping instruction is given or any shipment is completed and also to ensure that the shipping product storage-site selection processing is only performed on only one shipping assistance device 100 at a time.

The shippable product storage-site information storage 25, in the shipping product storage-site selection processing described further below, stores shippable product storage-site information that is information indicating a product storage-site that is able to ship the product in the order received from the order originator.

In the shipping product storage-site selection processing described further below, the shipping product storage-site candidate storage 26 stores a candidate (shipping product storage-site candidate) of a product storage-site that may be selected as a product storage-site for shipping a product in the order received from the order originator.

In the shipping product storage-site selection processing described further below, the order information storage 27 stores order information that is information regarding an order received from the order originator. The order information, as illustrated in FIG. 15, contains various types of information including an order originator name, an order originator code, a delivery destination, a delivery due-date, a number of types of products ordered, a name of the ordered product, a product code and an order quantity. In a case in which the order originator orders two or more types of products at the same time, three sets of information “the product name, the product code, and the order quantity” in the order information indicate the number of types of products ordered.

The following three cases are considered as delivery destinations included in the order information. The first case is a case in which the address of the order originator is used as the delivery location to make a direct delivery to the order originator from the product storage-site. In this case, the delivery location code of the order originator information is entered as the information indicating the delivery destination. The second case involving two-step transportation where the address of the business-site nearest to the address of the order originator is used and then the business-site nearest to the order originator makes a delivery to the order originator. In this case, the business-site code in the business-site information is entered as information indicating the delivery destination. The third case is a case in which the address of the product storage-site nearest to the address of the order originator is used and the order originator goes to the product storage-site to pick up the product. In this case, the product storage-site code of the product storage-site information is entered as the information indicating the delivery destination.

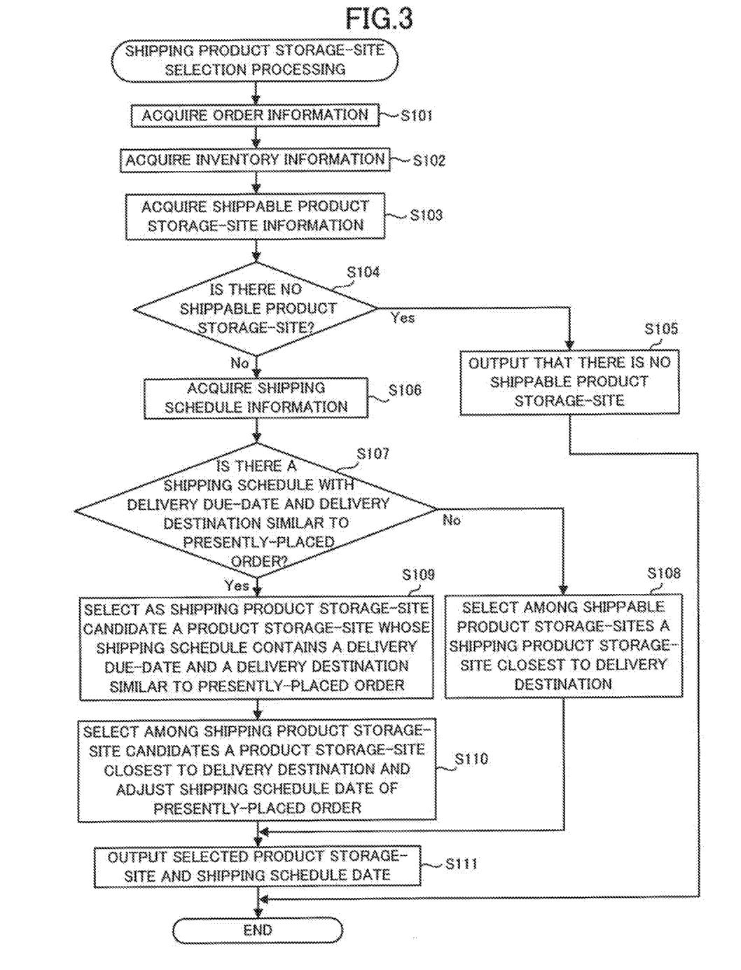

The shipping assistance device 100 acquires an order from the order originator and selects a product storage-site that is able to consolidate the product of an existing order of the order originator and the product of the presently-placed order of the order originator and ship the products as a consolidated shipment. By doing so, the shipping assistance device 100 can improve task-efficiency for the receipt of packages by the order originator. This shipping product storage-site selection processing is described with reference to FIG. 3.

First, the order information acquirer 11 acquires an order from the order originator, and stores the information regarding the order (order originator name, order originator code, delivery destination, delivery due-date, number of types of products ordered, name of ordered product, product code, and order quantity as illustrated in FIG. 15) into the order information storage 27 (step S101).

An order may be placed by the order originator either via a direct network (for example, when a webpage-based order form is filled in and transmitted or when an email is transmitted) or by telephone or facsimile (FAX). Orders placed by the order originator via the direct network are acquired by the order information acquirer 11 via the communicator 33. When placing an order by telephone or FAX, the user (shipping manager) of the shipping assistance device 100 enters the order details using the inputter 31, and the order information acquirer 11 acquires the inputted order details.

Next, the controller 10, acquires, via the communicator 33, inventory information (product storage-site name, product storage-site code, product name, product code, and shippable inventory quantity as illustrated in FIG. 10) of the product storage-sites, and stores the acquired inventory information into the inventory information storage 23 (step S102). Here, acquiring inventory information of all of the products in the inventory of each of the product storage-sites is unnecessary. It is sufficient to acquire only the inventory information of the ordered product. In order to do so, it is sufficient to use the product code included in the order information extracted in step S101 to extract only the inventory information containing the product code.

Next, for all product storage-sites whose shippable inventory for products ordered is equal to or greater than the order quantity of the products included in the order information stored in the order information storage 27, the shippable product storage-site information acquirer 12 acquires shippable product storage-site information that is information indicating these product storage-sites. Then, the acquired shippable product storage-site information is stored into the shippable product storage-site information storage 25 (step S103). The shippable product storage-site information acquirer 12 acquires the information indicating the shippable product storage-sites by referring to the inventory information stored in the inventory information storage 23. For example, an order is assumed to be “3 units of product x and 2 units of product y” as illustrated in FIG. 15. Also, the shippable inventories of the respective product storage-sites, as illustrated in FIG. 10, are assumed to be as follows: “10 units of product x, 1 unit of product y, and 9 units of product z” for the product storage-site a; “2 units of product x, 10 units of product y and 5 units of product z” for the product storage-site b; and “20 units of product x, 7 units of product y, and 2 units of product z” for the product storage-site c. Since only the product storage-site c has an inventory equal to or greater than 3 units of product x and 2 units of product y, the product storage-site c is the only shippable product storage-site.

Then, the controller 10 determines whether or not there is a shippable product storage-site based on the shippable product storage-site information that is stored into the shippable product storage-site information storage 25 during the processing in step S103 (step S104). If there is no shippable product storage-site (Yes in step S104), the controller 10 causes the outputter 32 to output the information “There is no shippable product storage-site” (step S105).

An order is described above in which an order originator fills in a webpage-based order form and transmits the form via a direct network and in such a case, the controller 10 may cause a message to be displayed on the webpage, via the communicator 33, indicating that there is no inventory. The message displayed is, for example, “Due to insufficient inventory, the order cannot be accepted at this time”. In the case where an order is received by telephone, FAX, or the like, the order originator will need to be contacted using the telephone number or FAX number the order originator used to place the order so the order originator can be informed that the order cannot be accepted at this time due to insufficient inventory. After step S105, the shipping product storage-site selection processing is completed.

If there is a shippable product storage-site (No in step S104), processing proceeds to step S106, and the shipping schedule information acquirer 13, acquires, via the communicator 33, the existing shipping schedule information of each of the product storage-sites that are able to perform the shipping and stores the acquired information into the shipping schedule information storage 24 (step S106). Here, the existing shipping schedule information is the product storage-site name, the product storage-site code, the order originator name, the order originator code, the delivery location, the delivery location code, and the shipping schedule date as illustrated in FIG. 11.

Next, the shipping product storage-site selector 14 first acquires information indicating the “delivery destination and delivery due-date” within the order information stored in the order information storage 27. Then the information indicating the “delivery location and shipping schedule date” within the existing shipping schedule information stored in the shipping schedule information storage 24 is acquired. Then the shipping product storage-site selector 14 determines whether or not there is shipping schedule information having (i) a delivery location that is the same as the delivery destination within the order information and (ii) a shipping schedule date that is early enough to be in time for the delivery due-date within the order information (step S107).

A specific example is described next. An order presently-placed by order originator A, as illustrated in FIG. 15, is assumed to have a delivery destination that is #000301 and a delivery due-date that is December 24. The existing shipping schedules of the respective product storage-sites are assumed to be as follows: “December 24 shipping schedule date for delivery to delivery location #000301”; and “December 23 shipping schedule date for delivery to delivery location #000501” both for the product storage-site a; “December 23 shipping schedule date for delivery to delivery location #000601” for the product storage-site b; and “December 23 shipping schedule date for delivery to delivery location #000301” and “December 24 shipping schedule date for delivery to delivery location #000601” both for the product storage-site c, as illustrated in FIG. 11. Here, a single day is assumed to be necessary for delivery to order originator A from any of the product storage-sites. From this, it can be understood that the shipping schedule information in the fourth row of FIG. 11 is shipping schedule information in which the delivery destination #000301 is the delivery location and the shipping schedule date (December 23) is early enough to be in time for delivery due-date December 24.

In the above-described example, the number of days for delivery to order originator A from the respective product storage-sites is assumed to be one day. In actuality though, the delivery period acquirer 15 acquires the number of delivery days required for delivery to order originator A from the respective product storage-sites based on the delivery location (acquired from order originator information storage 21) of order originator A, and the respective addresses (acquired from product storage-site information storage 22) of the product storage-sites.

Within the existing shipping schedule information, if there is no shipping schedule information having both (i) a delivery location that is the same as the delivery destination within the order information and (ii) a shipping schedule date that is early enough to be in time for the delivery due-date within the order information (No in step S107), processing proceeds to step S108. In step S108, the shipping product storage-site selector 14 acquires an address of the delivery location by using the code of the delivery destination within the order information (FIG. 15) stored in the order information storage 27.

A supplementary description is provided regarding the acquisition of address of the delivery location performed using this code of the delivery destination. The shipping product storage-site selector 14 acquires the address of the delivery location based on the code of the delivery destination. In other words, if the code of the delivery destination is the same as the delivery location code, the shipping product storage-site selector 14 acquires the address of the delivery location from the order originator information (FIG. 8) stored in the order originator information storage 21. If the code of the delivery destination is the same as the product storage-site code, the shipping product storage-site selector 14 acquires the address of the delivery location from the product storage-site information (FIG. 9) stored in the product storage-site information storage 22. If the code of the delivery destination is the same as the business operator code, the shipping product storage-site selector 14 acquires the address of the delivery location from the business-site information (not illustrated).

Then, the address of the product storage-site indicated in the shippable product storage-site information stored in the shippable product storage-site information storage 25 is acquired from the product storage-site information (FIG. 9) stored in the product storage-site information storage 22. Then the shipping product storage-site selector 14 selects among the product storage-sites indicated in the shippable product storage-site information stored in the shippable product storage-site information storage 25 a product storage-site that is closest (lowest freight cost) to the address of the delivery location (step S108). Then, processing proceeds to step S111.

In step S108, although the shipping product storage-site selector 14 may perform selection of the product storage-site closest to the delivery location based on information indicating the address of the product storage-site and the address of the delivery location, a table recorded with the nearest product storage-sites for each delivery location may be prepared and referenced instead. This table is similar to a priority product storage-site information storage 28 described further below.

Within the existing shipping schedule information, if there is shipping schedule information having both (i) a delivery location that is the same as the delivery destination within the order information and (ii) a shipping schedule date that is early enough to be in time for the delivery due-date within the order information (Yes in step S107), processing proceeds to step S109. Then, the shipping product storage-site selector 14 extracts from among the shipping schedule information stored in the shipping schedule information storage 24 all the shipping schedule information having both (i) a delivery location that is the same as the delivery destination within the order information and (ii) a shipping schedule date that is early enough to be in time for the delivery due-date within the order information. Then, all product storage-site codes within the extracted shipping schedule information are stored into the shipping product storage-site candidate storage 26 (step S109). Then, processing proceeds to step S110.

In step S110, the shipping product storage-site selector 14 acquires the address of the delivery location by using the code of the delivery destination within the order information (FIG. 15) stored in the order information storage 27. Next, the shipping product storage-site selector 14 acquires the address of the product storage-site that is stored in the shipping product storage-site candidate storage 26 from the product storage-site information (FIG. 9) that is stored in the product storage-site information storage 22. The shipping product storage-site selector 14 selects among the product storage-sites stored in the shipping product storage-site candidate storage 26 a product storage-site that is closest (lowest freight cost) to the address of the delivery location. Then, the shipping schedule date corresponding to the presently-placed order is adjusted to match the shipping schedule date in the existing shipping schedule information for the selected product storage-site, “having both (i) a delivery location that is the same as the delivery destination within the order information and (ii) a shipping schedule date that is early enough to be in time for the delivery due-date within the order information” (step S110). After doing so, processing proceeds to step S111.

In step S110, although the shipping product storage-site selector 14 may perform selection of the product storage-site closest to the delivery location based on information indicating the addresses, as described for the processing in step S108, a table recorded with the nearest product storage-sites for each delivery location may be prepared and referenced instead. This table is similar to the priority product storage-site information storage 28 described further below.

In step S111, the controller 10 causes the outputter 32 to output information indicating the product storage-site selected by the shipping product storage-site selector 14 and the shipping schedule date. Then the shipping product storage-site selection processing is completed.

In Embodiment 1, preferentially selecting a product storage-site having an existing shipping schedule with a delivery due-date and a delivery destination similar to that of a presently-placed order enables a product of a presently-placed order to be shipped together with other products to be shipped from the selected product storage-site. Accordingly, the arrival dates for delivery to the order originator of these products can be consolidated, thereby improving task-efficiency for the receipt of packages by the order originator.

Embodiment 2

In Embodiment 1, the shipping assistance device 100 alone performs selection of the shipping product storage-site. However, in a case in which nationwide there are multiple business sites managing shipping and there is a shipping assistance device 100 for each business site, it would be inefficient to manage order originator information, product storage-site information, inventory information, shipping schedule information and the like on a per-shipping assistance device 100 basis. In such a case, efficiency could be improved if the information is consolidated together and managed by a shipping assistance server.

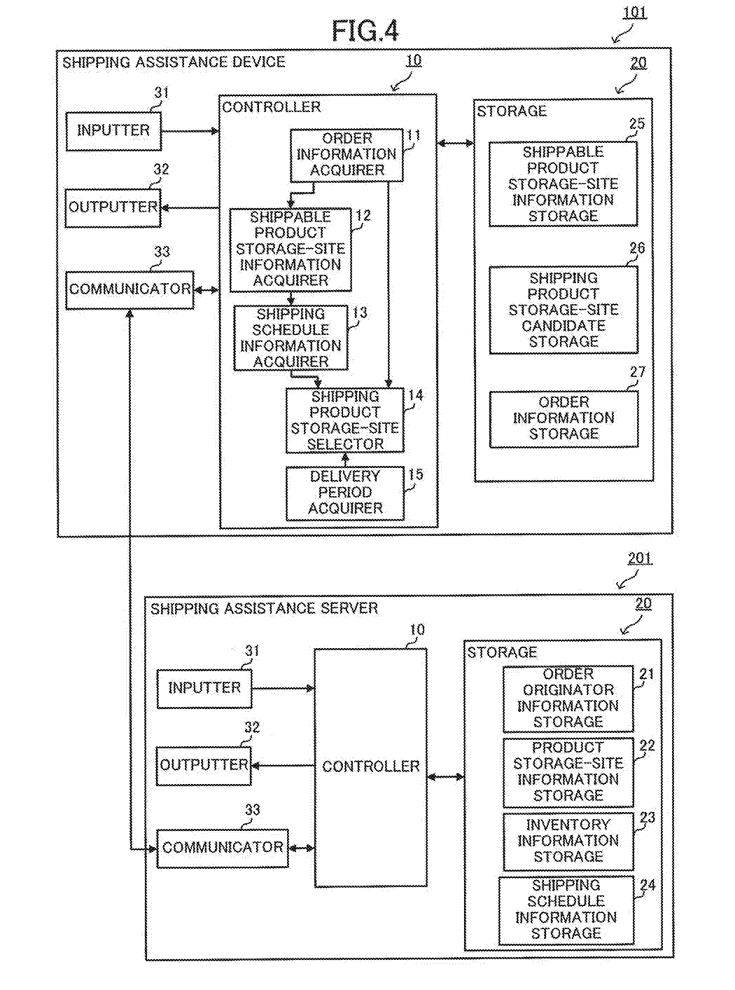

Embodiment 2 in which shipping product storage-site selection processing is shared between a shipping assistance device 101 and a shipping assistance server 201 is described with reference to FIG. 4. Embodiment 2 is different from Embodiment 1 in that the storage 20 of the shipping assistance device 101 does not include the order originator information storage 21, the product storage-site information storage 22, the inventory information storage 23, and the shipping schedule information storage 24, whereas the storage 20 of the shipping assistance server 201 does include the order originator information storage 21, product storage-site information storage 22, inventory information storage 23, and the shipping schedule information storage 24. Since the other aspects of the Embodiment 2 are the same as that in Embodiment 1, the description in Embodiment 2 mainly centers on the differences relative to Embodiment 1.

The order originator information storage 21 stores order originator information such as that illustrated in FIG. 8. The product storage-site information storage 22 stores information regarding product storage-sites that store products for delivery to order originators, as illustrated in FIG. 9. The information described above has the same contents as that described in Embodiment 1 and the updating of the information is also performed at the same timing as described in Embodiment 1.

However, since the information is stored in the storage 20 of the shipping assistance server 201, when the shipping assistance device 101 acquires this information, the acquiring is performed via communication. In other words, with the communicator 33 of the shipping assistance device 101 and the communicator 33 of the shipping assistance server 201 in communication with each other, the shipping assistance device 101 performs acquisition by receiving the information stored in the order originator information storage 21 and the product storage-site information storage 22 in the storage 20 of the shipping assistance server 201.

The information stored in the inventory information storage 23 likewise has fundamentally the same contents as that described in Embodiment 1, as illustrated in FIG. 10. In Embodiment 1 however, each time an order is received, it is sufficient to store only the inventory information containing the product code included in the order information. In contrast to this, the shipping assistance server 201 is constantly performing overall management of the inventory (product arrivals, product shipments, reservations based on orders, and the like) of all the product storage-sites, and updates the inventory information stored in the inventory information storage 23 each time inventory information is modified at any of the product storage-sites.

When the shipping assistance device 101 acquires inventory information, the communicator 33 of the shipping assistance device 101 and the communicator 33 of the shipping assistance server 201 are in communication with each other, and the shipping assistance device 101 performs acquisition by receiving the information stored in the inventory information storage 23 in the storage 20 of the shipping assistance server 201.

Similar to that in Embodiment 1, in a case where an order is received at the same time new inventory arrives or inventory is shipped and there are two or more shipping assistance devices 101 in operation at the same time, there is a possibility that the inventory quantity will be changed during the shipping product storage-site selection processing described further below. This necessitates the use of exclusive control to prevent an order from being accepted at the same time any new inventory arrives or any inventory is shipped and to ensure that the shipping product storage-site selection processing is performed on only one shipping assistance device 101 at a time.

The information stored in the shipping schedule information storage 24 likewise has fundamentally the same contents as that described in Embodiment 1, as illustrated in FIG. 11. In Embodiment 1 however, each time an order is received, only a product storage-site that is able to ship the ordered product is acquired and stored as shipping schedule information. In contrast to this, the shipping assistance server 201 performs overall management of shipping schedule information (product storage-site name, product storage-site code, order originator name, order originator code, delivery location, delivery location code, and shipping schedule date) that is information regarding schedules for shipping from each product storage-site to each delivery location for all product storage-sites. Therefore, when a new shipping instruction is given to one of the product storage-sites, the shipping assistance server 201 additionally stores shipping schedule information corresponding to the new shipment in the shipping schedule information storage 24. Then, each time the shipping is completed, the shipping assistance server 201 deletes the shipping schedule information corresponding to the shipment that is completed from the shipping schedule information storage 24.

Similar to that in Embodiment 1, in a case where an order is received at the same time a new shipment instruction is given or shipping is completed and there are two or more shipping assistance devices 101 in operation at the same time, there is a possibility that the shipping schedule information will be changed during the shipping product storage-site selection processing described further below. This necessitates the use of exclusive control to prevent an order from being accepted at the same time any new shipment instruction is given or any shipping is completed and to ensure that the shipping product storage-site selection processing is performed on only one shipping assistance device 101 at a time.

Next, the shipping product storage-site selection processing that is performed by the shipping assistance device 101 is described with reference to FIG. 3, however since a majority of the processing details are as described in Embodiment 1, the description here mainly centers on the differences relative to Embodiment 1.

The processing in step S101 is the same as that in Embodiment 1. In step S102, the controller 10 of the shipping assistance device 101 acquires, via the communicator 33, the inventory information (product storage-site name, product storage-site code, product name, product code, shippable inventory quantity) of each of the product storage-sites stored in the inventory information storage 23 of the shipping assistance server 201 (step S102). Here, acquiring inventory information of all of the products in the inventory of each of the product storage-sites is unnecessary. Instead, only the inventory information of the ordered product is acquired by querying the shipping assistance server 201 for the inventory information containing the product code, using the product code included in the order information acquired in step S101.

The processing in step S103 is the same as that in Embodiment 1, except that in Embodiment 2, the inventory information acquired in Step S102 is used as inventory information instead of the inventory information stored in the inventory information storage 23.

The processing in step S104 and step S105 is the same as that in Embodiment 1. In step S106, the shipping schedule information acquirer 13, via the communicator 33, acquires the existing shipping schedule information (product storage-site name, product storage-site code, order originator name, order originator code, delivery location, delivery location code, and shipping schedule date) of each of the product storage-sites stored in the shipping schedule information storage 24 of the shipping assistance server 201 (step S106).

The processing in step S107 is the same as that in Embodiment 1, except that in Embodiment 2, the shipping schedule information acquired in Step S106 is used as shipping schedule information instead of the shipping schedule information stored in the shipping schedule information storage 24.

The processing in step S108 is the same as that in Embodiment 1, except that in Embodiment 2, when acquiring an address of a delivery location, the shipping product storage-site selector 14 (i) acquires the address of the delivery location by querying the shipping assistance server 201 for the address of the delivery location using the code of the delivery destination stored in the order information storage 27, and (ii) acquires the address of the product storage-site by querying the shipping assistance server 201. Also, when selection of a product storage-site nearest to a delivery location is performed using the table (table that is stored in the storage 20 of the shipping assistance server 201, the table being similar to that of the priority product storage-site information storage 28 described further below) recorded with the nearest product storage-sites for each delivery location, the shipping assistance server 201 can be made to use the delivery location code to search for the nearest product storage-site based on this table.

The processing in step S109 is the same as that in Embodiment 1, except that in Embodiment 2, the shipping product storage-site selector 14 queries the shipping assistance server 201 for any product storage-sites, in the shipping schedule information stored in the shipping schedule information storage 24, “having both (i) a delivery location that is the same as the delivery destination and (ii) a shipping schedule date that is early enough to be in time for the delivery due-date”, and stores all such product storage-sites into the shipping product storage-site candidate storage 26.

The processing in Step S110 is the same as that in Embodiment 1, except that in Embodiment 2, when acquiring an address of a delivery location as well as an address of a product storage-site and a shipping schedule date in existing shipping schedule information, acquisition is performed by querying the shipping assistance server 201. Specifically, the shipping product storage-site selector 14 queries the shipping assistance server 201 for the address of the delivery location using the code of the delivery destination stored in the order information storage 27 to acquire the address of the delivery location. Further, the shipping product storage-site selector 14 queries the shipping assistance server 201 for the address of the product storage-site to also acquire the address of the product storage-site. Also, the shipping assistance server 201 is queried to acquire a shipping schedule date in the existing shipping schedule information for the selected product storage-site having both (i) a delivery location that is the same as the delivery destination and (ii) a shipping schedule date that is early enough to be in time for the delivery due-date”. Also, when selection of a product storage-site nearest to a delivery location is performed using the table (table that is stored in the storage 20 of the shipping assistance server 201, the table being similar to that of the priority product storage-site information storage 28 described further below) recorded with the closest product storage-sites for each delivery location, the shipping assistance server 201 can be made to use the delivery location code to search for the nearest product storage-site based on this table.

The processing in step S111 is the same as the processing in step S111 of Embodiment 1.

The hardware configuration of the shipping assistance device 101 and the hardware configuration of the shipping assistance server 201 are both the same as that of the shipping assistance device 100 as illustrated in FIG. 1.

In Embodiment 2, similar to that in Embodiment 1, preferentially selecting a product storage-site having an existing shipping schedule with a delivery due-date and a delivery destination similar to that of a presently-placed order enables a product of a presently-placed order to be shipped together with other products to be shipped from the selected product storage-site. Accordingly, the arrival dates for delivery to the order originator of these products can be consolidated, thereby improving task-efficiency for the receipt of packages by the order originator. As compared with Embodiment 1, the overall management of the inventory information, the shipping schedule information, and the like by the shipping assistance server 201 reduces the strain that is exerted in managing information regarding product storage-sites in the shipping assistance devices 101.

Embodiment 3

Regarding criteria for selecting a shipping product storage-site in Embodiments 1 and 2, “a product storage-site having a shipping schedule with the same delivery destination and delivery date” is selected as the highest priority. When more than one such product storage-site exists, a product storage-site that is closest (and with the lowest freight cost) to the delivery destination is selected among the product storage-sites. Regarding criteria for selecting a product storage-site in Embodiment 3, unlike in Embodiments 1 and 2, the product storage-site that is nearest to the delivery destination is selected as the highest priority. In a case in which all of the products ordered cannot be shipped from the nearest product storage-site, a product storage-site that can ship all of the products ordered is preferentially selected. Also, if there are multiple shipping product storage-site candidates for shipping, a product storage-site having “a shipping schedule with the same delivery destination and the delivery date” and “a product storage-site having a high inventory quantity of the products ordered” are preferentially selected.

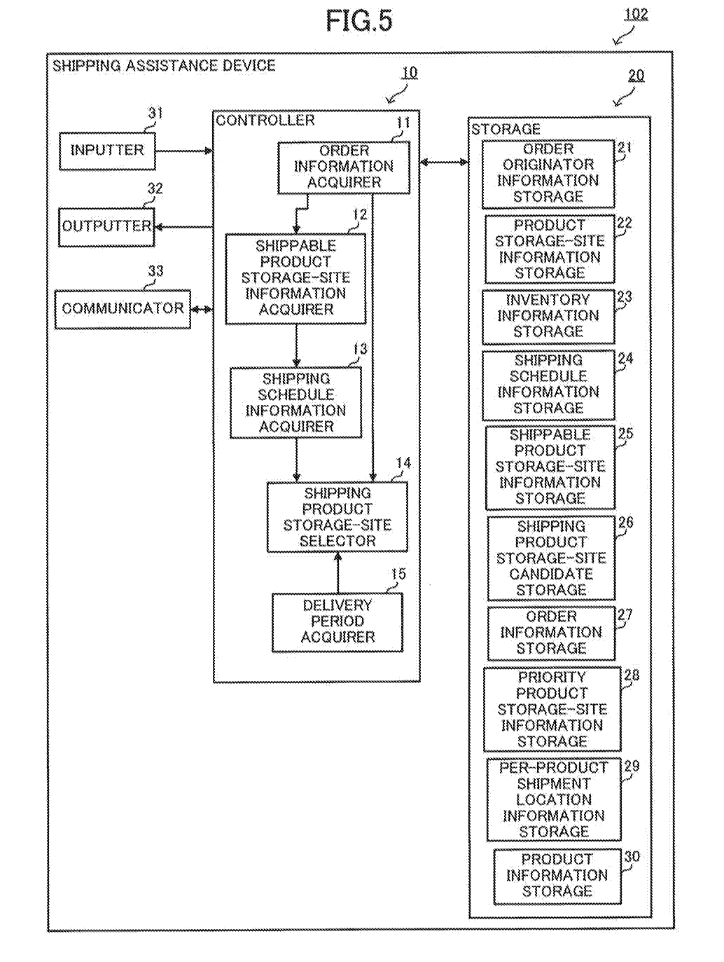

The hardware configuration for the shipping assistance device 102 according to Embodiment 3 of the present disclosure is the same as that of the shipping assistance device 100 according to Embodiment 1 as illustrated in FIG. 1. Also, a functional block diagram of the shipping assistance device 102 according to Embodiment 3 of the present disclosure is illustrated in FIG. 5. As compared with the functional block diagram of the shipping assistance device 100 according to Embodiment 1, the functional block diagram of the shipping assistance device 102 is the same, except that the storage 20 further includes the priority product storage-site information storage 28, a per-product shipment location information storage 29, and a product information storage 30.

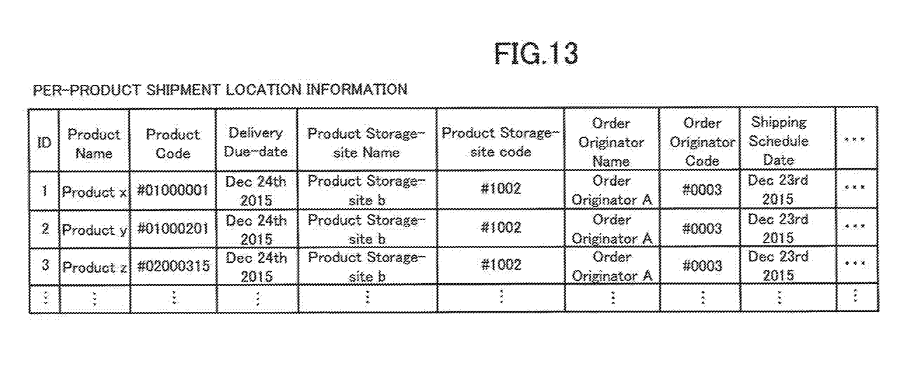

For all of the order originators stored in the order originator information storage 21, the priority product storage-site information storage 28 stores priority product storage-site information indicating a priority ranking, on a delivery location basis, of product storage-sites that ship products. Typically, the priority ranking of the product storage-site closest to the delivery location of the order originator is “1”, the priority ranking of the product storage-site second closest is “2”, and subsequent product storage-sites are likewise given a priority ranking in order of closest-to-farthest from the delivery location. The priority product storage-site information, as illustrated in FIG. 12, contains an order originator name, an order originator code, a delivery location code, a priority ranking number, a product storage-site name, and a product storage-site code.

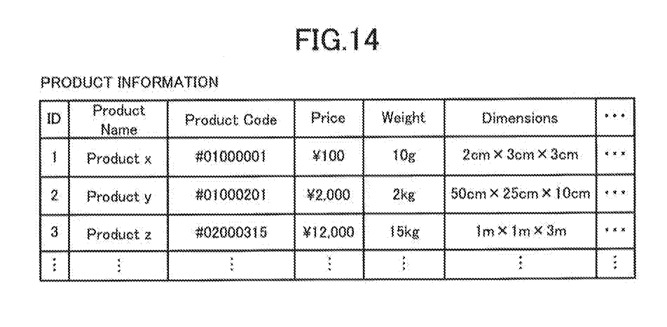

The per-product shipment location information storage 29 stores per-product shipment location information indicating, on a per-product basis for all the products ordered, each product and the product storage-site from which the product is to be shipped. The per-product shipment location information contains a product name, a product code, a delivery due-date, a product storage-site name, a product storage-site code, an order originator name, an order originator code, and a shipping schedule date, as illustrated in FIG. 13.

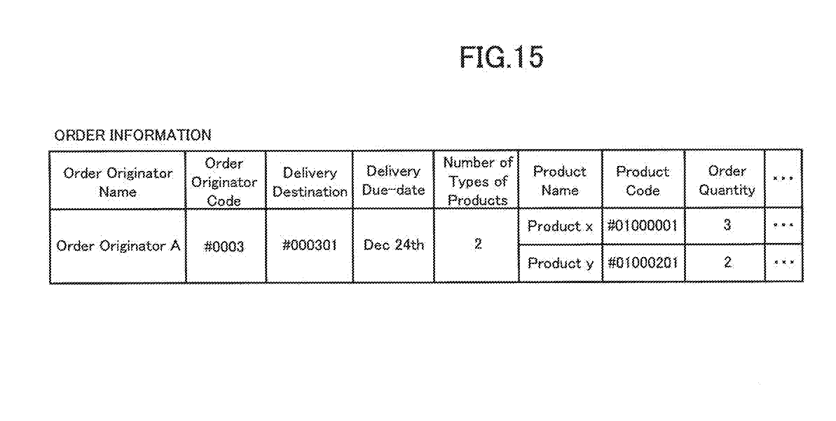

The product information storage 30 stores product information that is information regarding all products that potentially may be delivered to the order originator. The product information, as illustrated in FIG. 14, contains various types of information including a product name, a product code, a price, a weight, and dimensions. When there is a new product to be handled, the shipping assistance device 100 additionally stores product information regarding the new product in the product information storage 30. Conversely, if a case arises where a product is no longer to be handled, the product information regarding the product that is no longer handled gets deleted from the product information storage 30.

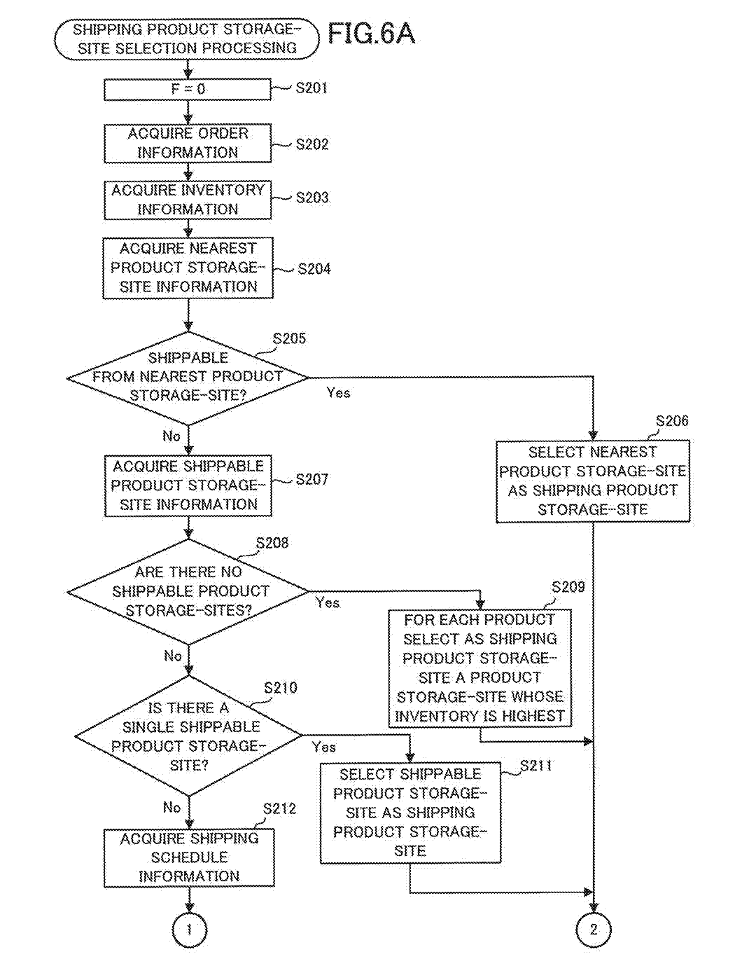

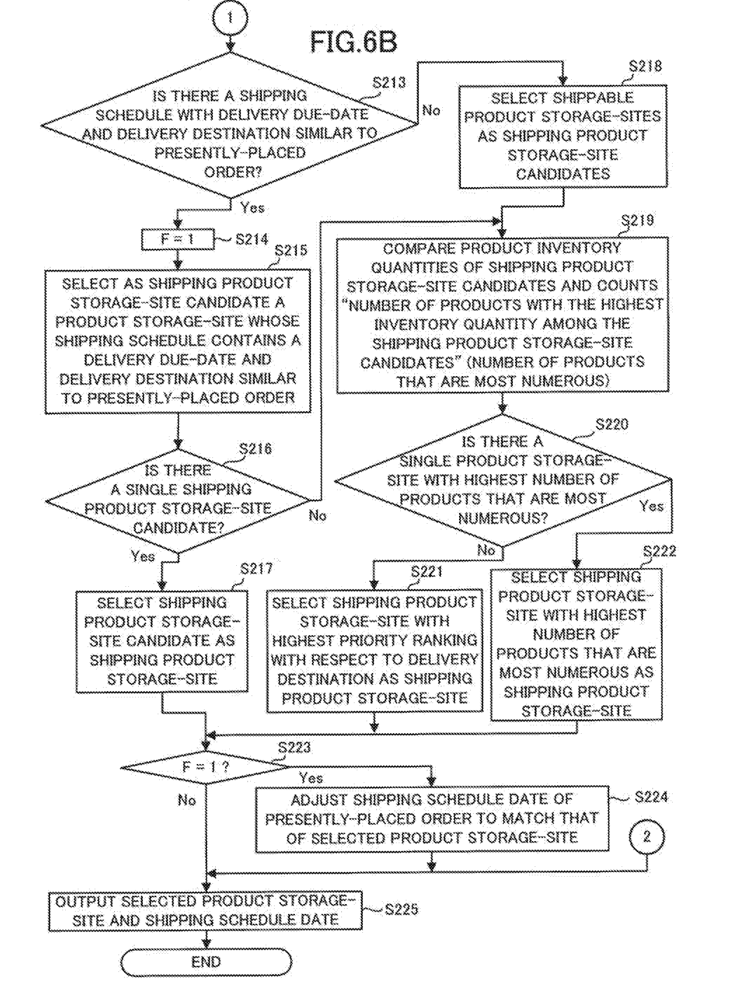

Next, the shipping product storage-site selection processing that is performed by the shipping assistance device 102 is described with reference to FIGS. 6A and 6B. First, the controller 10 clears variable F (step S201). Variable F is a flag indicating whether or not there is a product storage-site that has an existing shipping schedule with a delivery due-date and a delivery destination similar to that of a presently-placed order. Next, the order information acquirer 11 acquires an order from an order originator. The order information (order originator name, order originator code, name of ordered product, product code, order quantity, delivery destination, delivery due-date) that is information, as illustrated in FIG. 15, regarding the order is stored in the order information storage 27 (step S202). The processing in step S202 is the same as the processing in step S101 in Embodiments 1 and 2.

Next, the controller 10 acquires the inventory information (product storage-site name, product storage-site code, product name, product code, and shippable inventory quantity) for each product storage-site via the communicator 33, and stores this information into the inventory information storage 23 as illustrated in FIG. 10 (step S203). Here, acquiring inventory information for all the products in the inventory of each product storage-site is unnecessary. It is sufficient to acquire only the inventory information for the products ordered. By using the product code included in the order information acquired in step S202, the inventory information included in the product code can be selectively extracted, and thus the inventory information containing the product code of the ordered product can be selectively acquired.

Next, the controller 10 extracts a delivery location code by using the code of the delivery destination within the order information stored in the order information storage 27. Then, the extracted delivery location code and the priority ranking number “1” are used to search the priority product storage-site information storage 28 and acquire information indicating the product storage-site that is nearest to the delivery location (and with the lowest freight cost) (step S204).

Next, the controller 10 refers to the inventory information of the nearest product storage-site among the inventory information stored in the inventory information storage 23 and determines whether or not all of the products ordered can be shipped from the nearest product storage-site (step S205). If there is sufficient inventory in the nearest product storage-site for all of the products ordered a determination of shippable status is made. If a determination of shippable status is made (Yes in step S205), the shipping product storage-site selector 14 selects the nearest product storage-site as the shipping product storage-site, sets the shipping schedule date for the shipping product storage-site such that the product arrives by the delivery due-date, and stores the selected shipping product storage-site and the set shipping schedule date into the per-product shipment location information storage 29 (step S206). Then, processing proceeds to step S225.

If the nearest product storage-site cannot ship all of the products ordered (No in step S205), the shippable product storage-site information acquirer 12 acquires, for all of the shippable product storage-sites, shippable product storage-site information that is information indicating these shippable product storage-sites. The term shippable product storage-site, as previously described, refers to a product storage-site whose inventory quantity is equal to or greater than the order quantity for all of the products stored in the order information storage 27. The shippable product storage-site information acquirer 12 can acquire information indicating the shippable product storage-site by referring to the information stored in the inventory information storage 23. Then, the shippable product storage-site information acquirer 12 stores all of the acquired shippable product storage-site information in the shippable product storage-site information storage 25 (step S207). Next, the controller 10 determines whether or not there is a shippable product storage-site (step S208).

If there is no shippable product storage-site (Yes in step S208), for each product, the shipping product storage-site selector 14 selects a product storage-site having the highest inventory quantity for the product, as the shipping product storage-site of the product. In this processing, the shipping product storage-site selector 14 selects, on a product by product basis for the products stored in the order information storage 27, a warehouse whose inventory quantity is the highest for the product, as the shipping warehouse of the product, and the shipping product storage-site selector 14 performs this selection one at a time for each of the products stored in the order information storage 27. Then, the shipping product storage-site selector 14 sets shipping schedule dates such that the products of each selected shipping product storage-site arrive by the delivery due-date, and stores the shipping product storage-sites and the set shipping schedule dates into the per-product shipment location information storage 29 (step S209). If all of the product storage-sites have an inventory quantity of “0” for all of the products, there are no shipping product storage-sites, and thus nothing gets stored into the per-product shipment location information storage 29.

If there are multiple product storage-sites with the highest inventory quantity, the shipping product storage-site selector 14 selects a product storage-site having the highest priority ranking with respect to the delivery location of the order originator as the shipping product storage-site, among the product storage-sites with the highest inventory quantity. The shipping product storage-site selector 14 can perform this selection by referring to the priority product storage-site information storage 28. Then, the shipping product storage-site selector 14 sets the shipping schedule date for the selected shipping product storage-site such that the product arrives by the delivery due-date, and stores the selected shipping product storage-site and the set shipping schedule date into the per-product shipment location information storage 29 (step S209). Then, processing proceeds to step S225. In step S209, the shipping product storage-site selector 14 is the equivalent of a per-product shipment location selector.

A specific example is described where an order of order originator A is, for example, “5 units of product x, 5 units of product y, and 5 units of product c”. The inventory amount for each of the product storage-sites is assumed to be as follows: “5 units of product x, 5 units of product y, and 3 units of product z” for the product storage-site a; “5 units of product x, 1 unit of product y, and 1 unit of product z” for the product storage-site b; and “3 units of product x, 3 units of product y, and 5 units of product z” for the product storage-site c. For product x, the product storage-site a has an inventory quantity of 5 units and the product storage-site b also has an inventory quantity of 5 units, and since these quantities are the same, the product storage-site with the high priority ranking stored in the priority product storage-site information storage 28 is selected. For product y, the product storage-site a has the highest inventory quantity so the product storage-site a is selected. For product z, the product storage-site c has the highest inventory quantity so the product storage-site c is selected. Since the product storage-site with the highest priority ranking with respect to the delivery location of order originator A is assumed to be the product storage-site b, the product storage-site b ships product x, the product storage-site a ships product y, and the product storage-site c ships product z in response to the order by order originator A.

Returning back to the description of step S208 in FIG. 6A, if there is a shippable product storage-site (No in step S208), the controller 10 determines whether or not there is just a single shippable product storage-site (step S210). If there is just a single shippable product storage-site (Yes in step S210), the shipping product storage-site selector 14 selects only that one shippable product storage-site as the shipping product storage-site. Then, the shipping product storage-site selector 14 sets the shipping schedule date for the selected shipping product storage-site such that the product arrives by the delivery due-date, and stores the selected shipping product storage-site and the set shipping schedule date into the per-product shipment location information storage 29 (step S211).

If there are multiple shippable product storage-sites (No in step S210), the shipping schedule information acquirer 13 acquires all the shipping schedule information from each of the shippable product storage-sites via the communicator 33, and stores the acquired shipping schedule information into the shipping schedule information storage 24 (step S212). Here, the shipping schedule information, as previously described, contains the product storage-site name, the product storage-site code, the order originator name, the order originator code, the delivery location, the delivery location code, and the shipping schedule date.

Then, the shipping product storage-site selector 14 determines whether or not there is information containing a delivery due-date and a delivery destination within the existing shipping schedule information similar to that of the presently-placed order, based on information indicating “the delivery destination and the delivery due-date” stored in the order information storage 27 (step S213). This determination is for determining whether or not there is shipping schedule information within the existing shipping schedule information stored in the shipping schedule information storage 24 having both (i) a delivery location that is the same as the delivery destination within the order information and (ii) a shipping schedule date that is early enough to be in time for the delivery due-date within the order information.

Within the existing shipping schedule information, if there is no information containing a delivery due-date and a delivery destination similar to that of the presently-placed order (No in step S213), the shipping product storage-site selector 14 stores all the shippable product storage-site information, which is stored in the shippable product storage-site information storage 25, into the shipping product storage-site candidate storage 26 (step S218). Then, processing proceeds to step S219.

Within the existing shipping schedule information, if there is information containing a delivery due-date and a delivery destination similar to that of the presently-placed order (Yes in step S213), the controller 10 sets variable F to 1 (step S214). Next, the shipping product storage-site selector 14 extracts from among the shipping schedule information stored in the shipping schedule information storage 24 all the shipping schedule information having both (i) a delivery location that is the same as the delivery destination within the order information and (ii) a shipping schedule date that is early enough to be in time for the delivery due-date within the order information.

Then, all product storage-site codes within the extracted shipping schedule information are stored into the shipping product storage-site candidate storage 26 (step S215).

Next, the controller 10 determines whether or not there is just a single shipping product storage-site candidate stored in the shipping product storage-site candidate storage 26 (step S216). If there is just a single shipping product storage-site candidate (Yes in step S216), the shipping product storage-site selector 14 selects the shipping product storage-site candidate as the shipping product storage-site. Then, the shipping product storage-site selector 14 sets the shipping schedule date for the selected shipping product storage-site such that the product arrives by the delivery due-date, and stores the selected shipping product storage-site and the set shipping schedule date into the per-product shipment location information storage 29 (step S217). Afterwards, processing proceeds to step S223. If there is not just a single shipping product storage-site candidate (No in step S216), processing proceeds to step S219.

In step S219, in order to select a product storage-site having the greatest number of products with the highest inventory quantity among the shipping product storage-site candidates, the shipping product storage-site selector 14 counts how many products there are with the highest inventory quantity for each product storage-site (step S219). Specifically, the shipping product storage-site selector 14, for each product storage-site, counts the ‘number of products with the highest inventory quantity among the shipping product storage-site candidates’ (number of products that are most numerous)”. To do this, variable Nᵢ indicating the number of products that are most numerous for each product storage-site i is first initialized to “0” and then the inventory quantities of all products listed as product j in the order information are compared for all of the product storage-sites that are shipping product storage-site candidates. If product storage-site m is the product storage-site with the highest inventory quantity for product j, then variable Nₘ is incremented by “1”. After this processing is repeated for all products listed as product j in the order information, variable Nᵢ finally is incremented to be equal to the number of products that are most numerous of product storage-site i.

Next, the shipping product storage-site selector 14 determines whether or not there is a single product storage-site with the highest number of products that are most numerous (step S220). If there is just a single product storage-site with the highest number of products that are most numerous (Yes in step S220), the shipping product storage-site selector 14 selects the product storage-site with the highest number of products that are most numerous as the shipping product storage-site. Then, the shipping product storage-site selector 14 sets the shipping schedule date for the selected shipping product storage-site such that the product arrives by the delivery due-date, and stores the selected shipping product storage-site and the delivery due-date into the per-product shipment location information storage 29 (step S222). Then, processing proceeds to step S223.

If there is not just a single product storage-site with the highest number of products that are most numerous (No in step S220), the shipping product storage-site selector 14 selects, as a shipping product storage-site, a product storage-site with the highest priority ranking with respect the delivery location of the order originator, among the product storage-sites with the highest number of products that are most numerous. The shipping product storage-site selector 14 can perform this selection by referring to the priority product storage-site information storage 28. Then, the shipping product storage-site selector 14 sets the shipping schedule date for the selected shipping product storage-site such that the product arrives by the delivery due-date, and stores the selected shipping product storage-site and the set shipping schedule date into the per-product shipment location information storage 29 (step S221). Then, processing proceeds to step S223.

For example, where an order is “one unit each for products x, y, and z”, the shippable inventory for each of the product storage-sites is assumed to be as follows: “5 units of product x, 1 unit of product y, and 1 unit of product z” for the product storage-site a; and “3 units of product x, 3 units of product y, and 2 units of product z” for the product storage-site b. In this case, since the product storage-site a has the highest inventory quantity of product x, variable Na corresponding to the product storage-site a is incremented by “1”, thus becoming “1”. Also, since the product storage-site b has the highest inventory quantity of product y, variable Nb corresponding to the product storage-site b is incremented by “1”, thus becoming “1”. Also, since the product storage-site b has the highest inventory quantity of product z, variable Nb corresponding to the product storage-site b is incremented by “1”, thus becoming “2”. Finally, since variable Na is “1” and variable Nb is “2”, the product storage-site with the greater number of products that are most numerous is the product storage-site b. Therefore, the product storage-site b is selected as the shipping product storage-site.

As another example, where an order is “one unit each for products x, y, and z”, the shippable inventory for each of the product storage-sites is assumed to be as follows: “5 units of product x, 1 unit of product y, and 2 units of product z” for the product storage-site a; and “3 units of product x, 3 units of product y, and 2 units of product z” for the product storage-site b. In this case, since the product storage-site a has the highest inventory quantity of product x, variable Na corresponding to the product storage-site a is incremented by “1”, thus becoming “1”. Also, since the product storage-site b has the highest inventory quantity of product y, variable Nb corresponding to the product storage-site b is incremented by “1”, thus becoming “1”. Also, since the product storage-site a and the product storage-site b both have the same inventory quantity of product z, variable Na corresponding to the product storage-site a and variable Nb corresponding to the product storage-site b are both incremented by “1”, thus both becoming “2”. Finally, since variable Na and variable Nb are both “2”, in this case, the priority product storage-site information storage 28 is referenced and either the product storage-site a or the product storage-site b is selected as the shipping product storage-site, whichever of the two has the higher priority ranking with respect to the delivery location.

In step S223, the controller 10 determines whether or not variable F is “1” (step S223). If variable F is not “1” (No in step S223), processing proceeds to step S225. If variable F is “1” (Yes in step S223), this means that there is a product storage-site that has an existing shipping schedule with a delivery due-date and a delivery destination that are similar to that of the presently-placed order, and thus processing proceeds to step S224 to consolidate the shipping schedule dates.

In step S224, the shipping product storage-site selector 14 adjusts the shipping schedule date corresponding to the presently-placed order to match the shipping schedule date in the existing shipping schedule information for the selected product storage-site “having both (i) a delivery location that is the same as the delivery destination and (ii) a shipping schedule date that is early enough to be in time for the delivery due-date” (step S224). Then, processing proceeds to step S225.

In step S225, the controller 10 causes the outputter 32 to output information indicating the product storage-site and the shipping schedule date that are stored in the per-product shipment location information storage 29 (step S225). Then, processing is completed. In step S209, in a case where there is not even a single shippable product storage-site even after searching the shippable product storage-site for each product, no information whatsoever such as that regarding the product storage-sites is to be stored into the per-product shipment location information storage 29. In step S225, in a case where the per-product shipment location information storage 29 contains no information whatsoever such as that regarding the product storage-sites, the controller 10 causes the outputter 32 to output information stating that the per-product shipment location information storage 29 contains no shippable product storage-site (step S225).

In Embodiment 3, in a case where all of the products included in the order from the order originator can be shipped from the product storage-site nearest to the order originator, delivery costs can be reduced by shipping from the nearest product storage-site. Also, in a case where shipping is performed from a product storage-site that is not the nearest product storage-site, preferentially selecting a product storage-site having an existing shipping schedule with a delivery due-date and a delivery destination similar to that of the presently-placed order enables a product of a presently-placed order to be shipped together with other product to be shipped from the selected product storage-site. Accordingly, the arrival dates for delivery to the order originator of these products can be consolidated, thereby improving task-efficiency for the receipt of packages by the order originator.

Similar to Embodiment 2, the shipping assistance device 102 in Embodiment 3 likewise is achieved by distribution between the shipping assistance device and the shipping assistance server, thereby reducing the strain that is exerted in managing information regarding product storage-sites in the shipping assistance devices. In such a case, the product information storage 30 and the priority product storage-site information storage 28 are placed inside the storage 20 of the shipping assistance server 201 and the per-product shipment location information storage 29 is placed inside the storage 20 of the shipping assistance device 102.

### Embodiment 4

In Embodiment 3, in the case where all of the products included in the order cannot be shipped from a single product storage-site, for each of such products, a product storage-site having the highest inventory quantity is selected as the shipping product storage-site. In the case of shipping each of such products, conceivably, a product storage-site having a shipping schedule with the same delivery destination and the same shipping schedule date as the product is preferentially selected. Such an example is described in Embodiment 4.

A hardware configuration of a shipping assistance device 103 according to Embodiment 4 of the present disclosure is the same as that of the shipping assistance device 100 according to Embodiment 1 as illustrated in FIG. 1. A functional block diagram of the shipping assistance device 103 according to Embodiment 4 of the present disclosure is the same as the functional block diagram of the shipping assistance device 102 according to Embodiment 3 as illustrated in FIG. 5.

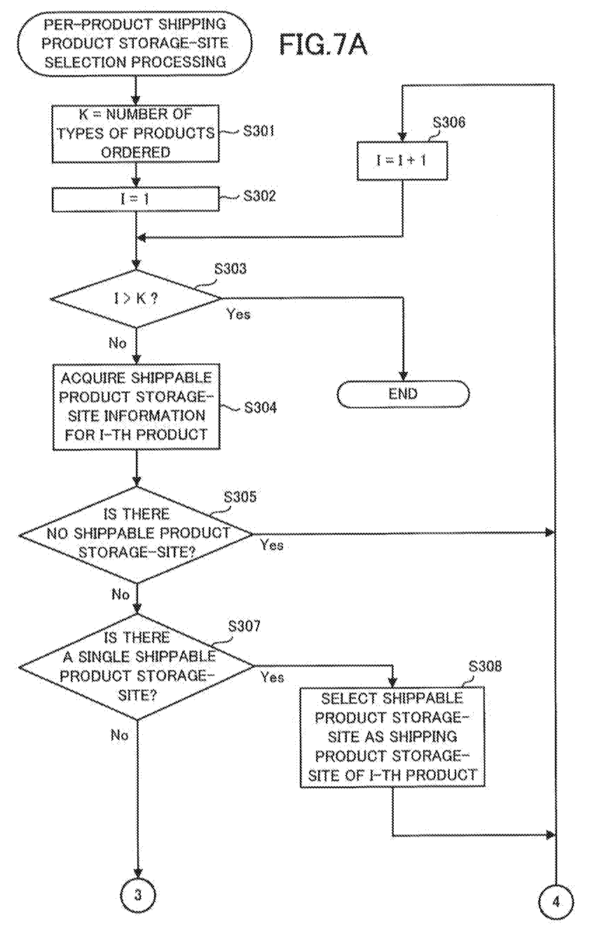

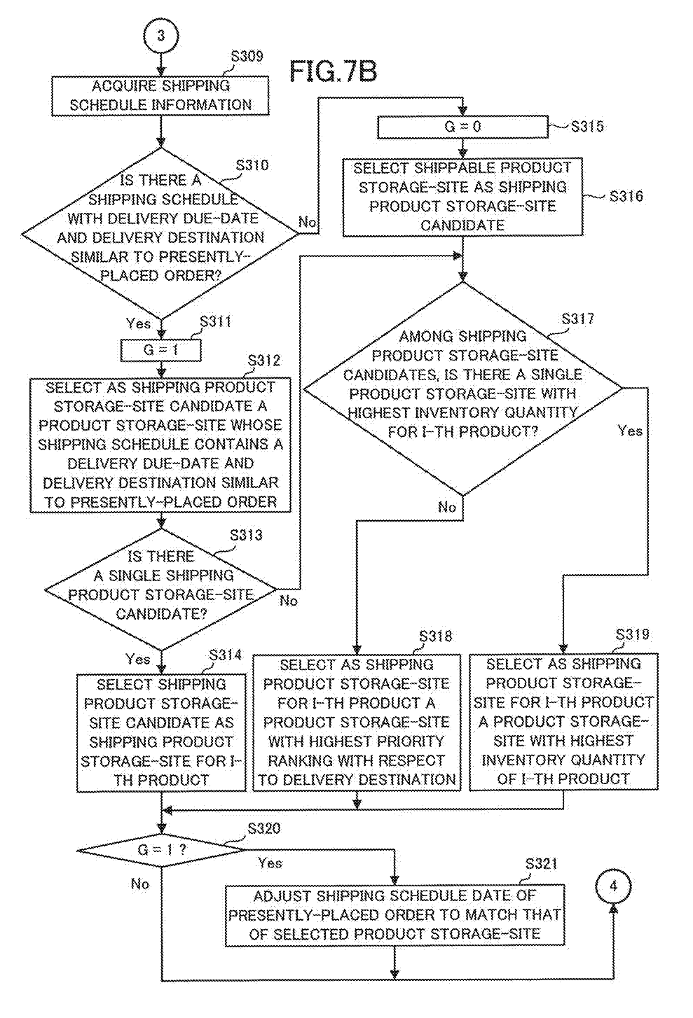

Third shipping product storage-site selection processing performed by the shipping assistance device 103 is the same as the shipping product storage-site selection processing (refer to FIGS. 6A and 6B) that is performed by the shipping assistance device 102, except for the processing in step S209. Therefore, details of the processing that is performed instead of that in step S209 is described with reference to FIGS. 7A and 7B.

First, the controller 10 sets variable K equal to the number of types of products ordered (step S301). Next, the controller 10 sets variable I, for indicating each type of product, equal to “1”, for selecting the shipping product storage-site per type of ordered product (step S302).

Next, the controller 10 determines whether or not variable I is greater than variable K (step S303). If variable I is greater than variable K (Yes in step S303), the shipping product storage-site selection for all the types of products ordered is ended, and thus the shipping product storage-site selection processing for each product ends. Thereafter, processing resumes from step S225 in FIG. 6B.

If variable I is less than or equal to variable K (No in step S303), the shippable product storage-site information acquirer 12 acquires for all of the shippable product storage-sites of the I-th product, information indicating these shippable product storage-sites. Here, the shippable product storage-site for the I-th product indicating the type of product refers to a product storage-site whose inventory quantity for the I-th product is equal to or greater than the order quantity for the I-th product. The shippable product storage-site information acquirer 12 can acquire the shippable product storage-site information that is information indicating the shippable product storage-site for the I-th product by referring to the inventory information stored in the inventory information storage 23. Then, the shippable product storage-site information acquirer 12 stores the acquired shippable product storage-site information in the shippable product storage-site information storage 25 (step S304). Next, the controller 10 determines whether or not there is a shippable product storage-site for the I-th product (step S305).

If there is no shippable product storage-site (Yes in step S305), the controller 10 increments variable I (step S306) by “1” and the processing returns to step S303. If there is a shippable product storage-site (No in step S305), the controller 10 determines whether or not there is just a single shippable product storage-site (step S307). If there is just a single shippable product storage-site (Yes in step S307), the shipping product storage-site selector 14 selects just the single shippable product storage-site as the shipping product storage-site of the I-th product. Then, the shipping product storage-site selector 14 sets the shipping schedule date in the information indicating the selected shipping product storage-site of the I-th product such that the product arrives by the delivery due-date, and stores the information with the set shipping schedule date into the per-product shipment location information storage 29 (step S308). Then, processing proceeds to step S306.

If there are multiple shippable product storage-sites (No in step S307), the shipping schedule information acquirer 13 acquires all of the shipping schedule information from each of the shippable product storage-sites via the communicator 33 and stores the acquired information into the shipping schedule information storage 24 (step S309). Here, the shipping schedule information, as previously described, contains the product storage-site name, the product storage-site code, the order originator name, the order originator code, the delivery location, the delivery location code, and the shipping schedule date.

Then, the shipping product storage-site selector 14 determines whether or not there is a delivery due-date and a delivery destination within the existing shipping schedule information that are the similar to that of the presently-placed order, based on information indicating “the delivery destination and the delivery due-date” stored in the order information storage 27 (step S310). This determination is for determining whether or not there is shipping schedule information within the existing shipping schedule information stored in the shipping schedule information storage 24 having both (i) a delivery location that is the same as the delivery destination within the order information and (ii) a shipping schedule date that is early enough to be in time for the delivery due-date within the order information.

A specific example is described next. An order presently-placed by order originator A, as illustrated in FIG. 15, is assumed to have a delivery destination that is #000301 and a delivery due-date that is December 24, for example. In the existing shipping schedules of the product storage-sites in FIG. 11, only the shipping schedule date in the first row is assumed to have been changed to December 22. In other words, the shipping schedules of the respective product storage-sites are assumed to be as follows: “December 22 shipping schedule date for delivery to delivery location #000301 and December 23 shipping schedule date for delivery to delivery location #000501” both for the product storage-site a; “December 23 shipping schedule date for delivery to delivery location #000601” for the product storage-site b; and “December 23 shipping schedule date for delivery to delivery location #000301 and December 24 shipping schedule date for delivery to delivery location #000601” both for the product storage-site c. Also, a single day is assumed to be necessary for delivery to order originator A from any of the product storage-sites. From this, it can be understood that the shipping schedule information in the first row and the fourth row of FIG. 11 is shipping schedule information in which “the delivery destination #000301 is the delivery location and the shipping schedule date (December 23) is early enough to be in time for delivery due-date December 24”.

Within the existing shipping schedule information, if there is no information containing a delivery due-date and a delivery destination similar to that of the presently-placed order (No in step S310), the controller 10 clears variable G (step S315). Variable G is a flag indicating whether or not there is a product storage-site having an existing shipping schedule with a delivery due-date and a delivery destination similar to that of the presently-placed order. Then, the shipping product storage-site selector 14 stores all of the shippable product storage-site information, which is stored in the shippable product storage-site information storage 25, in the shipping product storage-site candidate storage 26 (step S316). Then, processing proceeds to step S317.

Within the existing shipping schedule information, if there is information containing a delivery due-date and a delivery destination similar to the delivery due-date and the delivery destination of the presently-placed order (Yes in step S310), the controller 10 sets variable G to “1” (step S311). Next, the shipping product storage-site selector 14 extracts from among the shipping schedule information stored in the shipping schedule information storage 24 all the shipping schedule information having both (i) a delivery location that is the same as the delivery destination within the order information and (ii) a shipping schedule date that is early enough to be in time for the delivery due-date within the order information. Then, all product storage-site codes within the extracted shipping schedule information are stored into the shipping product storage-site candidate storage 26 (step S312).

Next, the controller 10 determines whether or not there is a single shipping product storage-site candidate stored in the shipping product storage-site candidate storage 26 (step S313). If there is a single shipping product storage-site candidate (Yes in step S313), for that product type, the shipping product storage-site selector 14 selects the shipping product storage-site candidate as the shipping product storage-site of the I-th product, indicating the type of product. Then, the shipping product storage-site selector 14 sets the shipping schedule date for the selected shipping product storage-site such that the product arrives by the delivery due-date, and stores the selected shipping product storage-site and the set shipping schedule date into the per-product shipment location information storage 29 (step S314). Then, processing proceeds to step S320. If there is not just a single shipping product storage-site candidate (No in step S313), processing proceeds to step S317.

In step S317, the shipping product storage-site selector 14 determines whether or not there is a single product storage-site whose inventory quantity of the I-th product, indicating the type of product, is the highest (step S317). If there is just a single product storage-site whose inventory quantity of the I-th product is the highest (Yes in step S317), the shipping product storage-site selector 14 selects the product storage-site whose inventory quantity of the I-th product is the highest as the shipping product storage-site of the I-th product. The shipping product storage-site selector 14 sets the shipping schedule date for the selected shipping product storage-site such that the product arrives by the delivery due-date, and stores the selected shipping product storage-site and the set delivery due-date into the per-product shipment location information storage 29 (step S319). Then, processing proceeds to step S320.

If there is not just a single product storage-site whose inventory quantity of the I-th product is the highest (No in step S317), the shipping product storage-site selector 14 selects among the product storage-sites whose inventory quantity of the I-th product is the highest, a product storage-site with the highest priority ranking with respect to the delivery location of the order originator, as the shipping product storage-site of the I-th product. The shipping product storage-site selector 14 can perform this selection by referring to the priority product storage-site information storage 28. Then, shipping product storage-site selector 14 sets the shipping schedule date for the selected shipping product storage-site such that the product arrives by the delivery due-date, and stores the selected shipping product storage-site and the set shipping schedule date into the per-product shipment location information storage 29 (step S318). Then, processing proceeds to step S320.

In step S320, the controller 10 determines whether or not variable G is “1” (step S320). If variable G is not “1” (No in step S320), processing proceeds to step S306. Conversely, if variable G is “1” (Yes in step S320), processing proceeds to step S321.

In step S321, the shipping product storage-site selector 14 adjusts the shipping schedule date of the I-th product to match the shipping schedule date in the existing shipping schedule information for the selected product storage-site “having both (i) a delivery location that is the same as the delivery destination and (ii) a shipping schedule date that is early enough to be in time for the delivery due-date” (step S321). Then, processing proceeds to step S306.

In step S306, the controller 10 increments variable I by “1” (step S306), and processing proceeds to step S303. After the above processing, if there is a shippable product storage-site for all the product types I (a value in a range of “1” to variable K is obtained for variable I), the optimal shipping product storage-site is selected.

For example, where an order is “one unit each for products x, y, and z”, the shippable inventory for each of the product storage-sites is assumed to be as follows: “5 units of product x” for the product storage-site a; and “3 units of product x, and 3 units of product y” for the product storage-site b. In such a case, since the product storage-site a has the highest inventory quantity of product x, the product storage-site a is selected as the shipping product storage-site of product x. Also, since the product storage-site b has the highest inventory quantity of product y, the product storage-site b is selected as the shipping product storage-site of product y. Also, since there is no product storage-site with an inventory of product z, there is no shippable product storage-site for product z.

As another example, where an order is “one unit each for products x, y, and z”, the shippable inventory for each of the product storage-sites is assumed to be as follows: “5 units of product x and 2 units of product z” for the product storage-site a; and “3 units of product x, 3 units of product y, and 2 units of product z” for the product storage-site b. In such a case, since the product storage-site a has the highest inventory quantity of product x, the product storage-site a is selected as the shipping product storage-site of product x. Also, since the product storage-site b has the highest inventory quantity of product y, the product storage-site b is selected as the shipping product storage-site of product y. Also, since the product storage-site a and product storage-site b have the same inventory quantity of product z, the priority product storage-site information storage 28 is referenced and either the product storage-site a or the product storage-site b is selected as the shipping product storage-site of product z, whichever of the two has the higher priority ranking with respect to the delivery location.

In a case where all of the products included in the order from the order originator cannot be shipped from a single product storage-site, the products must be shipped from different product storage-sites. However, in Embodiment 4, even in such a case, products included in the order of the order originator can be shipped together with other products from each of the product storage-sites. Accordingly, the arrival dates for delivery to the order originator can be partially consolidated, thereby improving task-efficiency for the receipt of packages by the order originator.

Similar to Embodiment 2, the shipping assistance device 103 in Embodiment 4 likewise is achieved by distribution between the shipping assistance device and the shipping assistance server, thereby reducing the strain that is exerted in managing information regarding product storage-sites in the shipping assistance devices. In such a case, the product information storage 30 and the priority product storage-site information storage 28 are placed inside the storage 20 of the shipping assistance server 201 and the per-product shipment location information storage 29 is placed inside the storage 20 of the shipping assistance device 103.

As described below in a modified example of Embodiments 3 and 4, processing (step S226) in which the shipping schedule date of a presently-placed order is adjusted to match the shipping schedule date of the selected product storage-site may be added just before the processing of step S225 in FIG. 6B. This processing added to the modified example is described next.

### MODIFIED EXAMPLE

The controller 10 acquires shipping schedule information of the product storage-site a from the shipping schedule information storage 24 based on the per-product shipment location information that is stored in the per-product shipment location information storage 29. Here, the per-product shipment location information is assumed to be equal to “product x, delivery due-date n, product storage-site a, order originator c, and shipping schedule date d”, for example. Also, the acquired shipping schedule information is assumed to be shipping schedule information s=“product storage-site a, order originator c, delivery location e, and shipping schedule date f”, for example. Next, the controller 10 searches through the shipping schedule information s for shipping schedule dates f regarding order originator c to find a shipping schedule date f that does not match with the shipping schedule date d. If all of the shipping schedule dates f match with the shipping schedule date d, the information stored in the per-product shipment location information storage 29 remains unchanged, and processing proceeds to step S225. If there is a shipping schedule date f that does not match with the shipping schedule date d, the controller 10 searches through the shipping schedule dates f to find a deliverable of product x that can be delivered early enough to be in time for the delivery due-date n.

If there is no shipping schedule date f early enough to be in time for the delivery due-date n, the information stored in the per-product shipment location information storage 29 remains unchanged and processing proceeds to step S225. Conversely, if there is a shipping schedule date f early enough to be in time for the delivery due-date n, the shipping schedule date d stored in the per-product shipment location information storage 29 is changed to the shipping schedule date f to be in time for the delivery-due date n (step S226). Then, processing proceeds to step S225. In this processing, the controller 10 is the equivalent of a shipping schedule date changer.

For example, in a presently-placed order by order originator A having a delivery due-date of December 26, the existing shipping schedule information of the nearest product storage-site (product storage-site a) of order originator A is assumed to contain “a shipping schedule date of December 24 for order originator A and December 23 for order originator B”. Also, the delivery period from product storage-site a to order originator A is assumed to be one day. As such, the shipping schedule date for the presently-placed order in step S206 is set to December 25 (because this delivery period enables delivery before (one day) the delivery due-date). However, even if the product of the presently-placed order is adjusted to “December 24 shipping schedule date for delivery to order originator A” included in the shipping schedule information of the product storage-site a and shipped together with the other products with this shipping schedule date, the product of the presently-placed order can be delivered to order originator A (on December 25) before the delivery due-date (December 26) of the presently-placed order. Moreover, order originator A can receive the package of the presently-placed order together with packages of prior orders on December 25 (thereby improving task-efficiency for the receipt of packages). Therefore, in such a case, the shipping schedule date for the presently-placed order is changed from the 25th to the 24th of December.

By adding this processing in step S226, the dates of arrival to the order originator can be further consolidated for products that are to be delivered to the same order originator, thereby further improving task-efficiency for the receipt of packages by the order originator.

Also, in all of the above-described embodiments, the delivery period that is acquired by the delivery period acquirer 15 is acquired based on the address of the product storage-site and the address of the delivery destination without taking the type of product into account. However, in case where a heavy product requires a longer delivery period than a light product or in a case where a large product requires a longer delivery period than a small product, such information for products that are to be delivered can also be taken into consideration for acquiring the delivery period.

In order to do so, (i) product information, which is stored in the product information storage 30, containing information indicating the weight and dimensions of a product and (ii) a table (second delivery period table) of weight and dimensions for delivery products recorded with the delivery period from the delivery location to the delivery destination are both utilized. Since the product information stored in the product information storage 30 contains information indicating the weight and dimensions of a product, the delivery period acquirer 15 refers to the second delivery period table using the information indicating the weight and dimensions of the delivery product, in addition to using the address of the product storage-site and the address of the delivery destination to acquire the delivery period for each product. The shipping product storage-site selector 14 may, on a per-product basis, set the shipping schedule date by subtracting the delivery period of each product from the delivery due-date.

The acquisition of a delivery period in accordance with a product by the delivery period acquirer 15 as described above enables arrival dates, on which products are to be delivered to an order originator, to be consolidated even in the case where there are products with different delivery periods, thereby improving task-efficiency for receipt of packages by the order originator. Conversely, in the case where the delivery period is not dependent on the weight and dimensions of a product, the product information storage 30 is unnecessary in Embodiments 3 and 4.

In all of the above-described embodiments, after the acquisition of information indicating a shippable product storage-site, the controller 10 acquires shipping schedule information of the shippable product storage-site, and then selects a shipping product storage-site candidate. However, the order of execution may be reversed. In other words, the controller 10 may first acquire the shipping schedule information, extract all product storage-sites with a shipping schedule that has a delivery due-date and a delivery destination similar to that of a presently-placed order, and then select among the extracted product storage-sites all the product storage-sites that have the sufficient inventory of the product in presently-placed order, as the shipping product storage-site candidates.

In any of the above-described embodiments, the individual functions may also be implemented by a general-purpose computer. Specifically, in the foregoing descriptions of the above embodiments, the program implemented by the controller 10 is stored beforehand in the ROM of the storage 20. However, the program may be stored in a non-transitory computer-readable recording medium such as a flexible disk, a compact disc read-only memory (CD-ROM), a digital versatile disc (DVD), magneto-optical disc (MO), or the like and distributed, and then by reading the program, the program may be installed onto a computer to provide the computer the ability to achieve the aforementioned individual functions. Moreover, if the individual functions are implemented by sharing the function between an operating system (OS) and the application programs, or are executed by both the OS and the application programs in cooperation with each other, the non-OS portion alone may be stored in the above-described recording medium.

Moreover, the programs may be superimposed onto a carrier wave and delivered via a communication network. As an example, the computer program may be posted on a bulletin board system (BBS) on a communication network to deliver the computer program via the network. Then, this computer program may be started and executed in a manner similar to other application programs under the control of the OS to execute the aforementioned processing.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2016-033722, filed on Feb. 25, 2016, the entire disclosure of which is incorporated by reference herein.

### INDUSTRIAL APPLICABILITY

The present disclosure can provide a shipping assistance device, a shipping assistance method, a program, and a shipping assistance system.

### REFERENCE SIGNS LIST

100, 101, 102, 103 Shipping assistance device
10 Controller
11 Order information acquirer
12 Shippable product storage-site information acquirer
13 Shipping schedule information acquirer
14 Shipping product storage-site selector
15 Delivery period acquirer
20 Storage
21 Order originator information storage
22 Product storage-site information storage
23 Inventory information storage
24 Shipping schedule information storage
25 Shippable product storage-site information storage
26 Shipping product storage-site candidate storage
27 Order information storage
28 Priority product storage-site information storage
29 Per-product shipment location information storage
30 Product information storage
31 Inputter
32 Outputter
33 Communicator
40 Internal bus
201 Shipping assistance server

1. A shipping assistance device comprising:
an order information acquirer to acquire order information including at least a number of types of products ordered, an order quantity, a delivery due-date, and a delivery destination;
a shippable product storage-site information acquirer to acquire information indicating product storage-sites that are able to ship an ordered product included in the order information acquired by the order information acquirer;
a shipping schedule information acquirer to acquire shipping schedule information for each product storage-site indicated in the information acquired by the shippable product storage-site information acquirer, the shipping schedule information including at least a shipping schedule date and a delivery location for a product that is scheduled to be shipped from a particular product storage-site of the product storage-sites;
a shipping product storage-site selector to select, based on the delivery due-date and the delivery destination included in the order information and the shipping schedule date and the delivery location included in the shipping schedule information, a product storage-site, as a shipping product storage-site, having shipping schedule information in which the delivery destination is the delivery location and the shipping schedule date is early enough to be in time for the delivery due-date; and
an outputter to output information indicating the product storage-site selected by the shipping product storage-site selector.

2. The shipping assistance device according to claim 1, further comprising:
a delivery period acquirer to acquire a delivery period that is a number of days required to deliver a product to an order originator from a product storage-site,
wherein the shipping product storage-site selector selects, based on the delivery period acquired by the delivery period acquirer and the shipping schedule date, a product storage-site, as a shipping product storage-site, that is able to ship is early enough to be in time for the delivery due-date.

3. The shipping assistance device according to claim 1, further comprising:
a priority product storage-site information storage to store a priority ranking of a product storage-site for each delivery location,
wherein when more than one product storage-site is selectable as the shipping product storage-site, the shipping product storage-site selector selects, among the selectable product storage-sites, a product storage-site with a highest priority ranking for the delivery destination stored in the priority product storage-site information storage, as a shipping product storage-site.

4. The shipping assistance device according to claim 1, further comprising:
an inventory information storage to store an inventory quantity for each product in each product storage-site,
wherein when more than one product storage-site is selectable as the shipping product storage-site, the shipping product storage-site selector selects, among the selectable product storage-sites, a product storage-site with a highest inventory quantity of the ordered product stored in the inventory information storage, as a shipping product-storage site.

5. The shipping assistance device according to claim 1, further comprising:
a per-product shipment location selector to select a shipping product storage-site for each product,
wherein
when there is no product storage-site that is selectable by the shipping product storage-site selector as a product storage-site that is able to ship all products ordered, the per-product shipment location selector selects a shipping product storage-site for each product, and
the outputter outputs information indicating the shipping product storage-site selected by the per-product shipment location selector for each product.

6. The shipping assistance device according to claim 1, further comprising:
a shipping schedule date changer to change the shipping schedule date of the ordered product to the shipping schedule date included in the shipping schedule information, when (i) the shipping schedule date included in the shipping schedule information of the shipping product storage-site and the shipping schedule date of the ordered product are different and (ii) delivery of the ordered product is early enough to be in time for the delivery due-date of the ordered product even after the shipping schedule date of the ordered product is changed to the shipping schedule date included in the shipping schedule information.

7. A shipping assistance method comprising:
a shippable product storage-site information acquisition step of acquiring information indicating product storage-sites that are able to ship an ordered product included in order information from an order originator;
a shipping schedule information acquisition step of acquiring shipping schedule information for the product storage-site indicated in the information acquired in the shippable product storage-site information acquisition step;
a shipping product storage-site selection step of selecting, based on a delivery due-date and a delivery destination included in the order information and a shipping schedule date and a delivery location included in the shipping schedule information, a product storage-site, as a shipping product storage-site, having shipping schedule information in which the delivery destination is the delivery location and the shipping schedule date is early enough to be in time for the delivery due-date; and
an output step of outputting information indicating the product storage-site selected in the shipping product storage-site selection step.

8. (canceled)

9. A shipping assistance system comprising;
a shipping assistance server; and
a shipping assistance device,
wherein
the shipping assistance server comprises:
an inventory information storage that stores an inventory quantity for each product in each product storage-site; and
a shipping schedule information storage that stores a shipping schedule for each of the products in each of the product storage-sites, and
the shipping assistance device comprises:
an order information acquirer that acquires order information including at least a number of types of products ordered, an order quantity, a delivery due-date, and a delivery destination;
a shippable product storage-site information acquirer that acquires, based on the inventory quantity stored in the inventory information storage, information indicating product storage-sites that are able to ship an ordered product included in the order information acquired by the order information acquirer;
a shipping schedule information acquirer that acquires, from the shipping schedule information storage, shipping schedule information for each product storage-site indicated in the information acquired by the shippable product storage-site information acquirer, the shipping schedule information including at least a shipping schedule date and a delivery location for a product that is scheduled to be shipped from a particular product storage-site of the product storage-sites;
a shipping product storage-site selector that selects, based on the delivery due-date and the delivery destination included in the order information and the shipping schedule date and the delivery location included in the shipping schedule information, a product storage-site, as a shipping product storage-site, having shipping schedule information in which the delivery destination is the delivery location and the shipping schedule date is early enough to be in time for the delivery due-date; and
an outputter that outputs information indicating the product storage-site selected by the shipping product storage-site selector.
